(19) United States
(12) Patent Application Publication
(10) Pub. No.: US 2015/0069045 A1
(43) Pub. Date: Mar. 12, 2015

(54) THERMAL CONTROL SYSTEMS AND METHODS USING THERMALLY GUARDED MULTIPLEXED SENSORS

(71) Applicant: Canon U.S. Life Sciences, Inc., Rockville, MD (US)

(72) Inventors: Johnathan S. COURSEY, Rockville, MD (US); Kenton C. Hasson, Germantown, MD (US); Gregory H. Owen, Clarksburg, MD (US); Hongye Liang, Clarksville, MD (US)

(73) Assignee: Canon U.S. Life Sciences, Inc., Rockville, MD (US)

(21) Appl. No.: 14/540,538

(22) Filed: Nov. 13, 2014

Related U.S. Application Data
(63) Continuation-in-part of application No. 12/825,476, filed on Jun. 29, 2010.
(60) Provisional application No. 61/903,488, filed on Nov. 13, 2013.
(60) Provisional application No. 61/221,452, filed on Jun. 29, 2009.

(51) Int. Cl. B01L 3/00; H05B 1/02; B01L 7/00; G01K 7/16

(52) U.S. Cl. CPC B01L 3/502715; G01K 7/16; H05B 1/0244; B01L 7/525; B01L 2200/147; B01L 2300/1827
USPC 219/494

(57) ABSTRACT

Methods and systems for thermal control of a device are disclosed having (i) a heated zone including two or more resistive sensors and (ii) a common electrode connected to each of the two or more resistive sensors. The two or more resistive sensors may be driven with heater control signals having alternating polarities. One or more portions of a thermal boundary of the heated zone may be heated by one or more thermal guard heaters.

### CROSS REFERENCE TO RELATED APPLICATION

This application claims the benefit of priority to U.S. Provisional Application Ser. No. 61/903,488, filed on Nov. 13, 2013, which is incorporated herein by reference in its entirety. This application is also a continuation-in-part of U.S. application Ser. No. 12/825,476, filed Jun. 29, 2010, which is incorporated herein by reference in its entirety and claims the benefit of Provisional Patent Application Ser. No. 61/221,452, filed Jun. 29, 2009, which is also incorporated herein by reference in its entirety.

### BACKGROUND

1. Field of Invention

The present invention relates to thermal control. More specifically, embodiments of the present invention relate to thermal control of microfluidic devices for performing one or more biological reactions. In some embodiments, the thermal control may be performed using thermally guarded multiplexed sensors.

2. Discussion of the Background

The detection of nucleic acids is central to medicine, forensic science, industrial processing, crop and animal breeding, and many other fields. The ability to detect disease conditions (e.g., cancer), infectious organisms (e.g., HIV), genetic lineage, genetic markers, and the like, is ubiquitous technology for disease diagnosis and prognosis, marker assisted selection, identification of crime scene features, the ability to propagate industrial organisms and many other techniques. Determination of the integrity of a nucleic acid of interest can be relevant to the pathology of an infection or cancer.

One of the most powerful and basic technologies to detect small quantities of nucleic acids is to replicate some or all of a nucleic acid sequence many times, and then analyze the amplification products. Polymerase chain reaction (PCR) is a well-known technique for amplifying deoxyribonucleic acid (DNA). With PCR, one can produce millions of copies of DNA starting from a single template DNA molecule. PCR includes phases of “denaturation,” “annealing,” and “extension.” These phases are part of a cycle which is repeated a number of times so that at the end of the process there are enough copies to be detected and analyzed. For general details concerning PCR, see Sambrook and Russell, Molecular Cloning—A Laboratory Manual (3rd Ed.), Vols. 1-3, Cold Spring Harbor Laboratory, Cold Spring Harbor, N.Y. (2000); Current Protocols in Molecular Biology, F. M. Ausubel et al., eds., Current Protocols, a joint venture between Greene Publishing Associates, Inc. and John Wiley & Sons, Inc., (supplemented through 2005) and PCR Protocols A Guide to Methods and Applications, M. A. Innis et al., eds., Academic Press Inc. San Diego, Calif. (1990).

The PCR process phases of denaturing, annealing, and extension occur at different temperatures and cause target DNA molecule samples to replicate themselves. Temperature cycling (thermocyling) requirements vary with particular nucleic acid samples and assays. In the denaturing phase, a double stranded DNA (dsDNA) is thermally separated into single stranded DNA (ssDNA). During the annealing phase, primers are attached to the single stranded DNA molecules. Single stranded DNA molecules grow to double stranded DNA again in the extension phase through specific bindings between nucleotides in the PCR solution and the single stranded DNA. Typical temperatures are 95° C. for denaturing, 55° C. for annealing, and 72° C. for extension. The temperature is held at each phase for a certain amount of time which may be a fraction of a second up to a few tens of seconds. The DNA is doubled at each cycle, and it generally takes 20 to 40 cycles to produce enough DNA for certain applications. To have good yield of target product, one has to accurately control the sample temperatures at the different phases to a specified degree.

More recently, a number of high throughput approaches to performing PCR and other amplification reactions have been developed, e.g., involving amplification reactions in microfluidic devices, as well as methods for detecting and analyzing amplified nucleic acids in or on the devices. Thermal cycling of the sample for amplification is usually accomplished in one of two methods. In the first method, the sample solution is loaded into the device and the temperature is cycled in time, much like a conventional PCR instrument. In the second method, the sample solution is pumped continuously through spatially varying temperature zones. See, for example, Lagally et al. (Analytical Chemistry 73:565-570 (2001)), Kopp et al. (Science 280:1046-1048 (1998)), Park et al. (Analytical Chemistry 75:6029-6033 (2003)), Hahn et al. (WO 2005/075683), Enzelberger et al. (U.S. Pat. No. 6,960,437) and Knapp et al. (U.S. Patent Application Publication No. 2005/0042639).

Many detection methods require a determined large number of copies (millions, for example) of the original DNA molecule, in order for the DNA to be characterized. Because the total number of cycles is fixed with respect to the number of desired copies, the only way to reduce the process time is to reduce the length of a cycle. Thus, the total process time may be significantly reduced by rapidly heating and cooling samples to process phase temperatures while accurately maintaining those temperatures for the process phase duration.

Accordingly, there is a need in the art for a compact microfluidic device capable of fast heating and highly precise thermal control.

### SUMMARY

The present invention relates to systems and methods capable of fast heating and highly precise thermal control of microfluidic devices. In some embodiments, this is accomplished by systems and methods for precisely determining and controlling the temperature of integrated thin film resistive thermal detectors in a microfluidic device. The present invention also relates to systems and methods capable high quality temperature measurements of microfluidic devices.

In one aspect, the present invention provides a microfluidic system having a microfluidic device and a heater control and measurement circuit. In one embodiment, the microfluidic device includes: a plurality of microchannels, a plurality of resistive temperature detectors (RTDs) each adjacent to a portion of an associated one of the plurality of microchannels, a first common electrode connected to each of the plurality of RTDs, and a second common electrode connected the first common electrode and to each of the plurality of RTDs. In one embodiment, the heater control and measurement circuit is configured to: (i) drive the plurality of RTDs with heater control signals having alternating polarities so that adjacent RTDs of the plurality are driven with heater control signals having opposite polarities, (ii) minimize the current in the first and second common electrodes, (iii) sense a temperature of each of the plurality of RTDs, and (iv) update the heater control signals using the sensed temperatures of the plurality of RTDs.

In some embodiments, the portions of the associated ones of the plurality of microchannels are located in a polymerase chain reaction (PCR) thermal zone of the microfluidic device or in a thermal melt zone of the microfluidic device. Also, the heater control and measurement circuit may include a system controller that is configured to generate the heater control signals based on a polymerase chain reaction (PCR) profile or a temperature ramp profile.

In some embodiments, the microfluidic device further includes: a second plurality of RTDs, a third common electrode connected to each of the second plurality of RTDs, and a fourth common electrode connected the third common electrode and to each of the second plurality of RTDs; and the heater control and measurement circuit is further configured to: (i) drive the second plurality of RTDs with heater control signals having alternating polarities so that adjacent RTDs of the second plurality of RTDs are driven with heater control signals having opposite polarities; (ii) minimize the current in the third and fourth common electrodes; (iii) sense a temperature of each of the second plurality of RTDs; and (iv) update the heater control signals using the sensed temperatures of the second plurality of RTDs.

In some embodiments, the heater control and measurement circuit is configured to update the heater control signals by modulating the amplitude of the heater control signals. The heater control signals may be alternating current signals, and the heater control signals may have opposite polarities when they are 180 degrees out of phase with each other.

In another aspect, the present invention provides a method for individually controlling a plurality of resistive thermal detectors (RTDs) of a microfluidic device of a microfluidic system, wherein the RTDs are each adjacent to a portion of an associated one of the plurality of microchannels. The method includes the steps of: generating heater control signals having alternating polarities to drive the plurality of RTDs, supplying the heater control signals to the plurality of RTDs so that adjacent RTDs of the plurality of RTDs are driven with heater control signals having opposite polarities, minimizing current in first and second common electrodes, wherein the first and second common electrodes are each connected to each RTD of the plurality of RTDs, sensing a temperature of each of the plurality of RTDs, and updating the heater control signals using the sensed temperatures of the plurality of RTDs. The heater control signals may be generated and updated based on a polymerase chain reaction (PCR) profile or on a temperature ramp profile. The minimizing the current in the first and second common electrodes may include determining a current imbalance between currents of the heating control signals supplied to the plurality of RTDs. Also, the minimizing the current in the first and second common electrodes may include sourcing/sinking the determined current imbalance. The method may also include preventing the heater control signals from having a voltage lower than a minimum voltage limit.

In some embodiments, the microfluidic device includes a second plurality of RTDs, and the method further includes: generating second heater control signals having alternating polarities to drive the second plurality of RTDs; supplying the second heater control signals to the second plurality of RTDs so that adjacent RTDs of the second plurality of RTDs are driven with second heater control signals having opposite polarities; minimizing current in third and fourth common electrodes, wherein the third and fourth common electrodes are each connected to each RTD of the second plurality of RTDs; sensing a temperature of each of the second plurality of RTDs; and updating the second heater control signals using the sensed temperatures of the second plurality of RTDs.

Each of the second plurality of RTDs may be adjacent to a second portion of an associated one of the plurality of microchannels. The heater control signals that drive the plurality of RTDs may be generated so that deoxyribonucleic acid (DNA) contained in the associated ones of the plurality of microchannels is amplified. The second heater control signals that drive the second plurality of RTDs may be generated so as to ramp the temperature of the second plurality of RTDs. The DNA amplification may be achieved through a polymerase chain reaction (PCR).

The microfluidic device may include a second plurality of microchannels. Each of the second plurality of RTDs may be adjacent to a portion of an associated one of the second plurality of microchannels. The first and second heater control signals that respectively drive the first and second plurality of RTDs may be generated so that deoxyribonucleic acid (DNA) contained in the portions of the associated ones of the plurality of microchannels and the second plurality of microchannels is amplified. The DNA amplification is achieved through a polymerase chain reaction (PCR).

The microfluidic device may include a second plurality of microchannels, each of the second plurality of RTDs being adjacent to a portion of an associated one of the second plurality of microchannels, and the first and second heater control signals that respectively drive the first and second plurality of RTDs are generated to ramp the temperature of the first and second plurality of RTDs.

In some embodiments, the heater control signals are updated by modulating the amplitude of the heater control signals. The heater control signals may be alternating current signals, the heater control signals have opposite polarities when they are 180 degrees out of phase with each other.

In another aspect, the present invention provides a microfluidic system including a microfluidic device and a heater control and measurement circuit. The microfluidic device may include a first microchannel; a second microchannel; a first electrode; a second electrode; a first common electrode; a second common electrode; a first resistive temperature detector (RTD) adjacent to a portion of the first microchannel and connected to the first electrode and to the first and second common electrodes; a second RTD adjacent to a portion of the second microchannel and connected to the second electrode and to the first and second common electrodes. The heater control and measurement circuit may include: a virtual ground circuit associated with the first and second common electrodes and configured to minimize the current in the first and second common electrodes, a first RTD control circuit and a second RTD control circuit. The virtual ground circuit may have: (i) an input connected to the first common electrode, and (ii) an output connected to the second common electrode. The first RTD control circuit may have: (i) an input connected to the first common electrode, and (ii) an RTD control output connected to the first electrode. The second RTD control circuit may have: (i) an input connected to the first common electrode, and (ii) an RTD control output connected to the second electrode. The heater control and measurement circuit is configured such that the first and second RTDs are driven with opposite polarities.

In another aspect, the present invention provides a method for individually controlling first and second resistive thermal detectors (RTDs) of a microfluidic device of a microfluidic system, wherein the first RTD is adjacent to a portion of a first microchannel of the microfluidic device, and the second RTD is adjacent to a portion of a second microchannel of the microfluidic device. The method includes: generating a first heater control signal for driving the first RTD and a second heater control signal for driving the second RTD; supplying the first heater control signal to the first RTD using a first electrode connected to the first RTD; supplying the second heater control signal to the second RTD using a second electrode connected to the second RTD; minimizing current in first and second common electrodes, wherein the first and second common electrodes are each connected to the first and second RTDs; and sensing a temperature of the first RTD and a temperature of the second RTD using a signal received from the first common electrode. The first and second RTDs may be driven with opposite polarities.

In another aspect, the present invention provides a microfluidic system including a microfluidic device and an RTD measurement circuit. The microfluidic device may include: a plurality of microchannels; a plurality of resistive temperature detectors (RTDs) each adjacent to a portion of an associated one of the plurality of microchannels; a first common electrode connected to each of the plurality of RTDs; and a second common electrode connected the first common electrode and to each of the plurality of RTDs. The RTD measurement circuit may be configured to: (i) invert a drive signal into an inverted drive signal; (ii) drive every other RTD of the plurality of RTDs with the drive signal; (iii) drive the RTDs of the plurality of RTDs that are not driven with drive signal with the inverted drive signal; (iv) minimize the current in the first and second common electrodes; and (v) sense a temperature of each of the plurality of RTDs.

In another aspect, the present invention provides a method for sensing the temperature of a plurality of resistive thermal detectors (RTDs) of a microfluidic device of a microfluidic system, wherein the RTDs are each adjacent to a portion of an associated one of the plurality of microchannels. The method may include: generating a drive signal; inverting the drive signal into an inverted drive signal; driving every other RTD of the plurality of RTDs with the drive signal; driving the RTDs of the plurality of RTDs that are not driven with drive signal with the inverted drive signal; minimizing current in first and second common electrodes, wherein the first and second common electrodes are each connected to each RTD of the plurality of RTDs; and sensing a temperature of each of the plurality of RTDs.

In another aspect, the present invention provides a microfluidic system including a microfluidic device and a heater control and measurement circuit. The microfluidic device may include: a plurality of microchannels; a plurality of resistive temperature detectors (RTDs) each adjacent to a portion of an associated one of the plurality of microchannels; and a common electrode connected to each of the plurality of RTDs. The heater control and measurement circuit may be configured to: (i) drive the plurality of RTDs with heater control signals having alternating polarities so that adjacent RTDs of the plurality are driven with heater control signals having opposite polarities; (ii) sense a temperature of each of the plurality of RTDs; and (iii) update the heater control signals by modulating the amplitude of the heater control signals in accordance with the sensed temperatures of the plurality of RTDs.

In another aspect, the present invention provides a method for individually controlling a plurality of resistive thermal detectors (RTDs) of a microfluidic device of a microfluidic system, wherein the RTDs are each adjacent to a portion of an associated one of the plurality of microchannels. The method may include: generating heater control signals having alternating polarities to drive the plurality of RTDs; supplying the heater control signals to the plurality of RTDs so that adjacent RTDs of the plurality of RTDs are driven with heater control signals having opposite polarities; sensing a temperature of each of the plurality of RTDs; and updating the heater control signals by modulating the amplitude of the heater control signals in accordance with the sensed temperatures of the plurality of RTDs.

One aspect of the invention may provide a system comprising a device, one or more thermal guard heaters, and a thermal control circuit. The device may include a heated zone including two or more resistive sensors. The device may include a common electrode connected to each of the two or more resistive sensors. The one or more thermal guard heaters may be configured to heat a portion of a thermal boundary of the heated zone. The thermal control circuit may be configured to: (i) drive the two or more resistive sensors with heater control signals, (ii) drive the one or more thermal guard heaters with guard heater control signals, (iii) measure the resistance of each of the two or more resistive sensors, and (iv) update the heater control signals using the measured resistances to balance a thermal load between the two or more resistive sensors by varying the guard heater control signals.

In some embodiments, the heater control signals have alternating polarities such that adjacent resistive sensors of the two or more resistive sensors are driven with heater control signals having opposite polarities. In some embodiments, the device may comprise two or more microfluidic channels that pass through the heated zone. In some embodiments, each of the two or more resistive sensors may be associated with a microfluidic channel of the two or more microfluidic channels. In some embodiments, the one or more thermal guard heaters are not associated with a microfluidic channel of the two or more microfluidic channels. In some embodiments, each of the one or more thermal guard heaters may comprise a resistive heater. In some embodiments, the one or more thermal guard heaters may comprise one or more non-contact lasers or one or more infrared heaters. In some embodiments, the common electrode may be a split common electrode comprising a pair of common electrode branches.

In some embodiments, the thermal control circuit may be configured to drive the two or more resistive sensors with heater control signals having alternating polarities such that an equal number of the two or more resistive sensors are driven with signals of positive and negative polarities.

In some embodiments, the thermal control circuit may be configured to optimize a ratio of a thermal guard heater drive voltage to a resistive heater drive voltage such that the two or more resistive heaters have substantially the same measured resistances and drive voltages. In some embodiments, the one or more thermal guard heaters may comprise a first thermal guard heater, the two or more resistive sensors may comprise a first resistive sensor that is adjacent to the first thermal guard heater, and the thermal control circuit may be configured to drive the first thermal guard heater with a voltage that is proportional to a voltage with which the first resistive sensor is driven. In some embodiments, the voltage with which the first thermal guard heater is driven may be equal to the voltage with which the first resistive sensor is driven multiplied by a constant, and the constant is within a range greater than or equal to 1 and less than or equal to 2. In some embodiments, the constant is equal to 1.5. In some embodiments, the thermal control circuit may be configured to measure the resistance of each of the one or more thermal guard heaters.

In some embodiments, the thermal control circuit may be configured to determine the one or more heater control signals used to drive the one or more thermal guard heaters based on the measured resistance of each of the one or more thermal guard heaters. In some embodiments, the one or more thermal guard heaters may comprise a first thermal guard heater, the two or more resistive sensors may comprise a first resistive sensor that is adjacent to the first thermal guard heater, and the thermal control circuit may be configured to drive the first thermal guard heater and the first resistive sensor with heater control signals having opposite polarities.

Another aspect of the invention may provide a thermal control method for a device comprising (i) a heated zone including two or more resistive sensors and (ii) a common electrode connected to each of the two or more resistive sensors. The method may comprise: driving the two or more resistive sensors with heater control signals; measuring the resistance of each of the two or more resistive sensors; updating the heater control signals using the measured resistances; and using one or more thermal guard heaters to heat at least a portion of a thermal boundary of the heated zone.

In some embodiments, the heater control signals may have alternating polarities such that adjacent resistive sensors of the two or more resistive sensors are driven with heater control signals having opposite polarities. In some embodiments, the two or more resistive sensors may be driven such that an equal number of the two or more resistive sensors are driven with signals of positive and negative polarities.

In some embodiments, the method may comprise: driving a first resistive sensor of the two or more resistive sensors with a first voltage, wherein the first resistive sensor is adjacent to a first thermal guard heater of the one or more thermal guard heaters; and driving the first thermal guard heater with a second voltage that is proportional to the first voltage. In some embodiments, the second voltage may be equal to the first voltage multiplied by a constant, and the constant may be within a range greater than or equal to 1 and less than or equal to 2. In some embodiments, the constant may be equal to 1.5.

In some embodiments, the method may comprise measuring the resistance of each of the one or more thermal guard heaters. In some embodiments, the method may comprise: determining one or more heater control signals used to drive the one or more thermal guard heaters based on the measured resistance of each of the one or more thermal guard heaters; and driving the one or more thermal guard heaters with the one or more heater control signals.

In some embodiments, the method may comprise driving a first resistive sensor of the two or more resistive sensors with a first heater control signal. The first resistive sensor may be adjacent to a first thermal guard heater of the one or more thermal guard heaters. The method may comprise driving the first thermal guard heater with a second heater control signal. The first and second heater control signals may have opposite polarities.

The above and other embodiments of the present invention are described below with reference to the accompanying drawings.

### BRIEF DESCRIPTION OF THE DRAWINGS

The accompanying drawings, which are incorporated herein and form part of the specification, illustrate various embodiments of the present invention. In the drawings, like reference numbers indicate identical or functionally similar elements. Additionally, the left-most digit(s) of the reference number identifies the drawing in which the reference number first appears.

FIG. 1 depicts a block diagram illustrating functional units of a microfluidic system according to one embodiment.

FIG. 2 depicts a top view of a microfluidic device of the microfluidic system according to one embodiment.

FIG. 3 depicts a resistive network for multiplexed thermal detectors of the microfluidic device of FIG. 2 according to one embodiment.

FIG. 4 depicts a block diagram illustrating functional units of a heater control and measurement circuit and their connections with electrodes of the microfluidic device of FIG. 2 according to one embodiment.

FIG. 5 depicts a block diagram illustrating further detail of the functional units of the heater control and measurement circuit of FIG. 4 and their connections with electrodes of the microfluidic device of FIG. 2 according to one embodiment.

FIG. 6 depicts a schematic diagram illustrating a thermal control circuit for a single resistive thermal detector according to one embodiment.

FIG. 7 depicts a schematic diagram illustrating a line driver according to one embodiment.

FIG. 8 depicts a schematic diagram illustrating a virtual ground circuit according to one embodiment.

FIG. 9 depicts a schematic diagram illustrating a bridge configuration according to one embodiment.

FIGS. 10A-10E depict schematic diagrams illustrating various low-pass filtering configurations that may be used in embodiments of the microfluidic system.

FIG. 11 depicts a flow chart showing a closed-loop thermal control algorithm according to one embodiment.

FIG. 12 depicts a flow chart showing a measured voltage to temperature conversion algorithm according to one embodiment.

FIG. 13 shows an example of a small current imbalance resulting from driving eight of the heaters shown in FIGS. 2 to 70° C. with alternating polarity combined with the non-uniform thermal load that must be sourced/sinked by the virtual ground circuit.

FIG. 14 depicts a block diagram illustrating alternating polarity temperature measurement of 4 sensors using a single driving signal in accordance with one embodiment.

FIG. 15 depicts a top view of a microfluidic device embodying aspects of the present invention.

FIG. 16 depicts a block diagram illustrating functional units of a heater control and measurement circuit and their connections with electrodes of a microfluidic device in accordance embodiments of the invention.

FIG. 17 depicts a block diagram illustrating connections with guard heater electrodes of a microfluidic device in accordance embodiments of the invention.

FIG. 18 depicts a schematic diagram illustrating a thermal control circuit for a single resistive thermal detector and a single guard heater in accordance with embodiments of the invention.

FIG. 19 is a graph illustrating interchannel standard deviation in melt temperature in a microfluidic device embodying aspects of the present invention.

FIGS. 20 and 21 are graphs illustrating negative derivative curves for calibration melts. FIG. 20 illustrates negative derivative curves for calibration melts performed with the guard heaters turned off, and FIG. 21 illustrates negative derivative curves for calibration melts performed using the guard heaters.

FIG. 22 is a graph illustrating an absolute value of a drive voltage used for the multiplexed sensors for various guard ratios.

FIG. 23 is a schematic diagram illustrating an example of a thermal guard heater driving circuit embodying aspects of the present invention.

### DETAILED DESCRIPTION OF PREFERRED EMBODIMENTS

Embodiments of the systems and methods for determining and controlling the temperature of integrated resistive thermal detectors in a microfluidic device are described herein with reference to the figures.

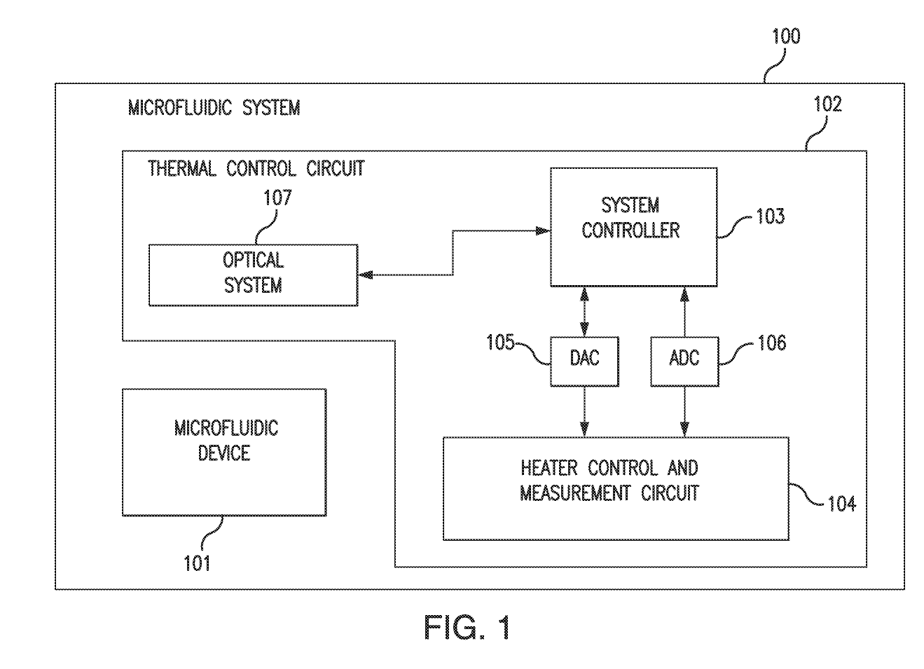

FIG. 1 illustrates a microfluidic system 100 according to one embodiment of the present invention. As shown in FIG. 1, microfluidic system 100 has a microfluidic device 101 and a thermal control circuit 102. Thermal control circuit 102 has a system controller 103, heater control and measurement circuit 104, digital to analog converter (DAC) 105 and analog to digital converter (ADC) 106. Although DAC 105 and ADC 106 are shown in FIG. 1 as separate from system controller 103 and heater control and measurement circuit 104, DAC 105 and ADC 106 may alternatively be part of system controller 103 or heater control and measurement circuit 104. In addition, thermal control circuit 102 may include an optical system 107 to monitor microfluidic device 101.

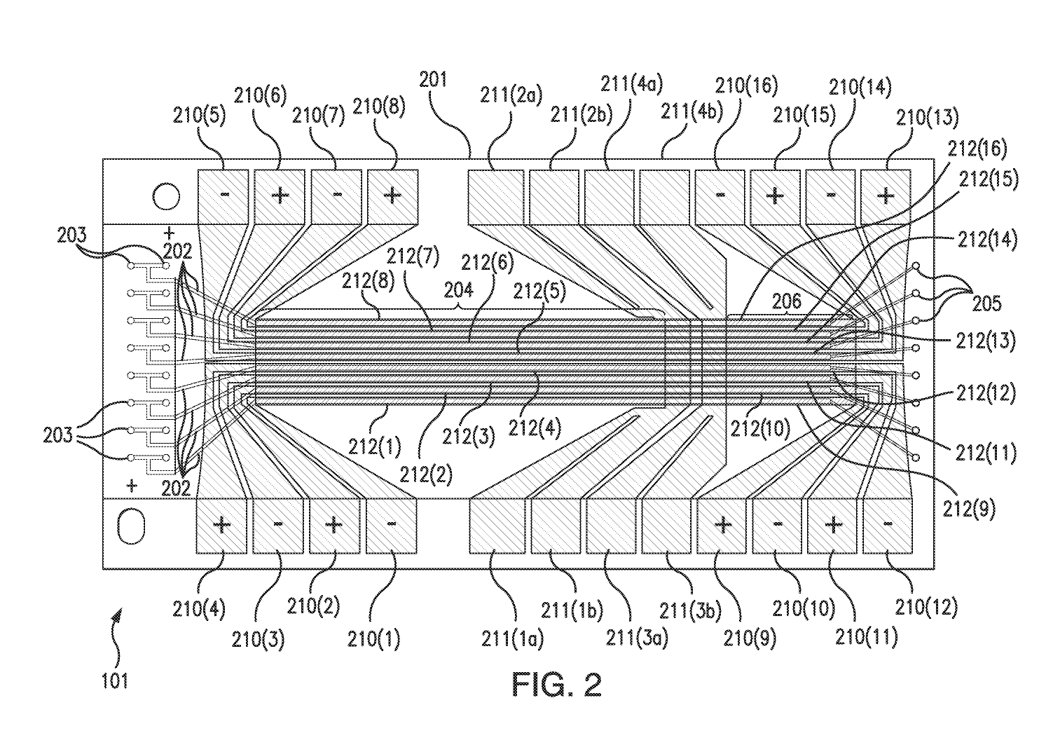

Compact microfluidic devices require numerous functions within a limited space. In one embodiment, the present invention is a highly efficient microfluidic device 101 for use in molecular diagnostics. Two possible specific applications are polymerase chain reaction (PCR) and high resolution thermal melt. The microfluidic device 101 shown in FIG. 2 illustrated a plurality of microchannels 202 that are adjacent to thin-film resistive temperature detectors (RTDs) 212, in accordance with one embodiment. For example, in one non-limiting embodiment, microchannels 202 may be underlain with RTDs 212. The RTDs 212 function as precise temperature sensors as well as quick response heaters. Further, to decrease waste heat and better thermally isolate separate functional zones 204 and 206, the thin-film RTDs include lead wires or electrodes 210 and 211 which are more conductive than the RTDs 212. The electrodes 210 and 211 may be any suitable conductive material and, in one preferred embodiment, are gold. The RTDs 212 may be made from any suitable resistive material that demonstrates good response to temperature and is capable of being used as a heater. Suitable RTD materials include, but are not limited to, platinum and nickel.

PCR is one of the most common and critical processes in molecular diagnostics and other genomics applications that require DNA amplification. In PCR, target DNA molecules are replicated through a three phase temperature cycle of denaturation, annealing, and extension. In the denaturation step, double stranded DNA is thermally separated into single stranded DNA. In the annealing step, primers hybridize to single stranded DNA. In the extension step, the primers are extended on the target DNA molecule with the incorporation of nucleotides by a polymerase enzyme.

Typical PCR temperatures are 95° C. for denaturation, 55° C. for annealing, and 72° C. for extension. The temperature during a step may be held for an amount of time from fractions of a second to several seconds. In principle, the DNA doubles in amount at each cycle, and it takes approximately 20 to 40 cycles to complete a desired amount of amplification. To have good yield of target product, one has to control the sample temperatures at each step to the desired temperature for each step. To reduce the process time, one has to heat and cool the samples to desired temperature very quickly, and keep those temperatures for the desired length of time to complete the synthesis of the DNA molecules in each cycle. This can be accomplished, in accordance with one embodiment, using microfluidic chip 101 with thin-film RTDs 212 as heaters.

As shown in FIG. 2, microfluidic device 101 may have a plurality of microfluidic channels 202 extending across a substrate 201. The illustrated embodiment shows eight channels 202; however, fewer or more channels could be included. Each channel 202 may include one or more inlet ports 203 (the illustrated embodiment shows two inlet ports 203 per channel 202) and one or more outlet ports 205 (the illustrated embodiment shows one outlet port 205 per channel 202). Each channel may include a first portion extending through a PCR thermal zone 204 and a second portion extending through a thermal melt zone 206. A sipper (not illustrated) can be used to draw liquid into the plurality of microfluidic channels 202.

The microfluidic device 200 further includes heater elements, which may be in the form of thin film resistive thermal detectors (RTDs) 212. In one embodiment, one or more heater element 212 are associated with each microfluidic channel 202 and are located adjacent to the microfluidic channel 202. For example, each microfluidic channel 202 may be situated above (or otherwise adjacent to) on one or more heating element 212. In the illustrated embodiment, heater element 212(1)-(8) are associated with the microfluidic channels 202 in PCR thermal zone 204 and heater elements 212(9)-(16) are associated with the microfluidic channels located in thermal melt zone 206. For example, in the non-limiting illustrated embodiment, heater elements 212(1) and 212(9) are associated with one microfluidic channel 202 with heater element 212(1) being located in PCR thermal zone 204 and heater element 212(9) being located in thermal melt zone 206.

In one embodiment, heater electrodes 210 and 211 provide electrical power to the plurality of heating elements 212. To best utilize the limited space provided by substrate 201 of microfluidic device 101 and reduce the number of electrical connections required, multiple RTDs share a pair of common electrodes 211. Heater electrodes 210 and 211 include individual electrodes 210 and common electrodes 211. Each pair of common electrodes includes, for example, a first common electrode 211(a) and a second common electrode 211(b). The pairs of common electrodes 211 allow the microfluidic sensors to be controlled in three-wire mode.

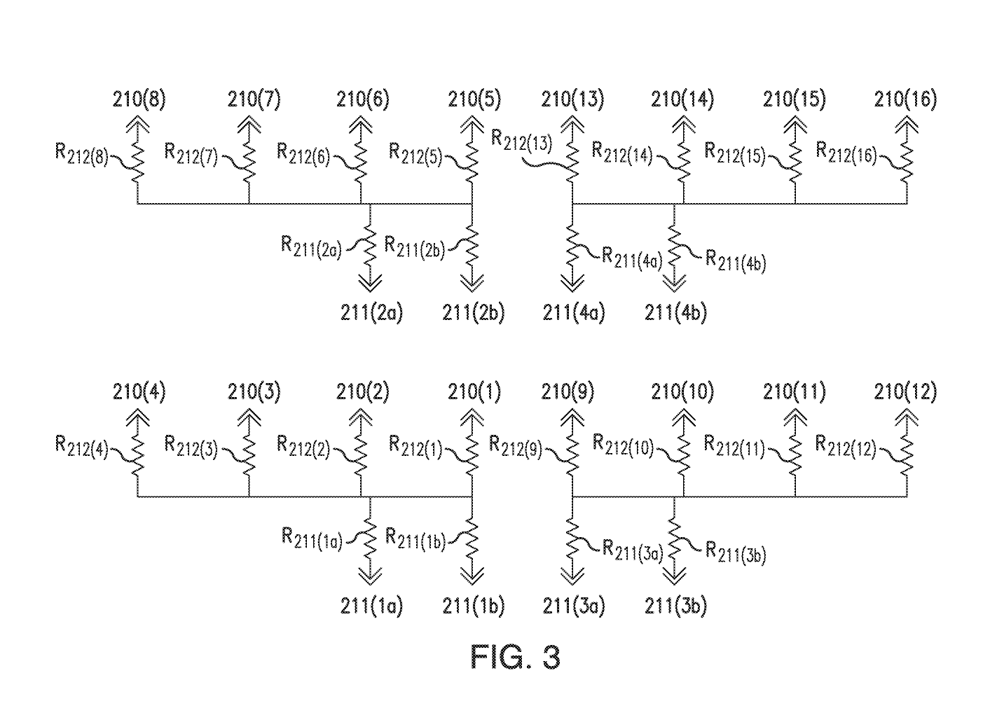

In the non-limiting illustrated embodiment, there are sixteen RTD heater elements 212(1)-212(16), sixteen individual electrodes 210(1)-210(16) and four common electrode pairs 211(1)-211(4). Accordingly, as illustrated in FIG. 2, there are four first common electrodes 211(1a)-211(4a) and four second common electrodes 211(1b)-211(4b). Each heater element 212 is connected to an individual electrode 210 and a pair of common electrodes 211. Multiple heater elements 212 share a pair of common electrodes 211 and are thereby multiplexed with the pair of common electrodes 211. For example, RTD 212(1) is connected to individual electrode 210(1) and a pair of common electrodes 211(1a) and 211(1b). FIG. 3 illustrates the thin-film resistance network associated with the RTDs 212 and electrodes 210 and 211 of the microfluidic device 101 shown in FIG. 2, in accordance with one embodiment.

Although the microfluidic device 101 and resistor network shown in FIGS. 2 and 3 has four heater elements 212 connected to each of the four pairs of common electrodes 211, more or fewer RTDs may be multiplexed with each pair of common electrodes 211. Furthermore, more or fewer pairs of common electrodes 211 may be used to create more or fewer multiplexed sets of heater elements.

In one embodiment, each of the heater elements 212 of microfluidic device 101 is independently controlled for rapid heating and temperature sensing. As a result, the temperature of a microfluidic channel 202 in PCR thermal zone 204 may be controlled independently of the temperature of the microfluidic channel 202 in thermal melt zone 206. Also, the temperature of each microfluidic channel 202 in a zone 204 or 206 may be controlled independently of the temperature of the other microfluidic channels 202 in the zone 204 or 206.

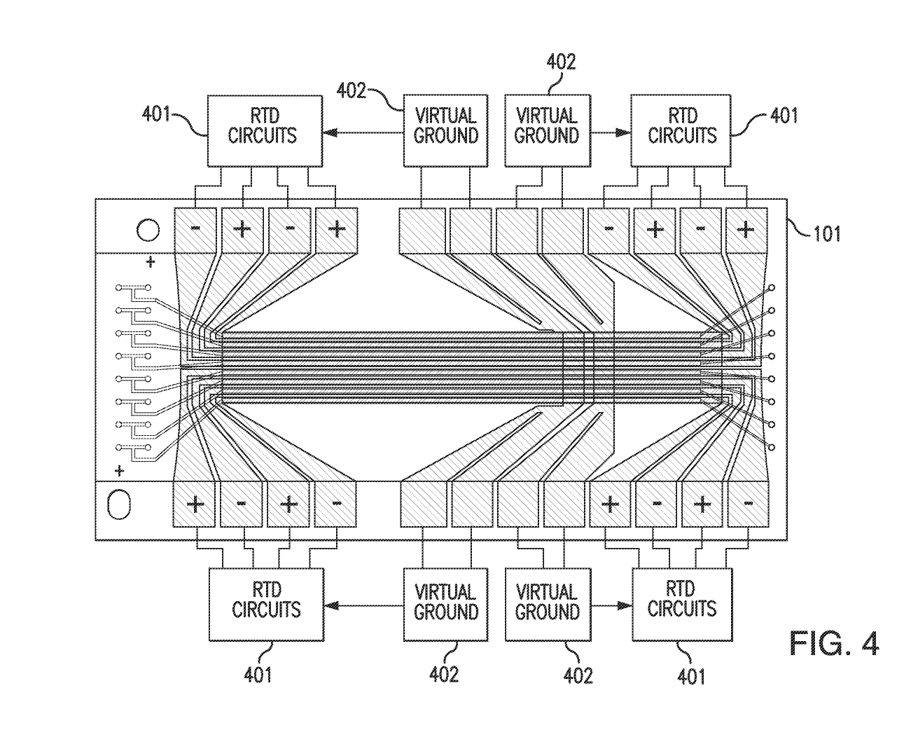

FIGS. 4-6 illustrate the configuration of heater control and measurement circuit 104 according to one embodiment. FIG. 4 shows the general configuration of heater control and measurement circuit 104 and, generally, the manner in which heater control and measurement circuit 104 is connected to the heater electrodes 210 of microfluidic device 101. The heater control and measurement circuit 104 may include groups of RTD control circuits 401 and virtual ground circuits 402, as shown in FIG. 4. Each group of RTD control circuits 401 is associated with a set of multiplexed RTDs 212. Each virtual ground circuit 402 is associated with one of pair of common electrodes 211.

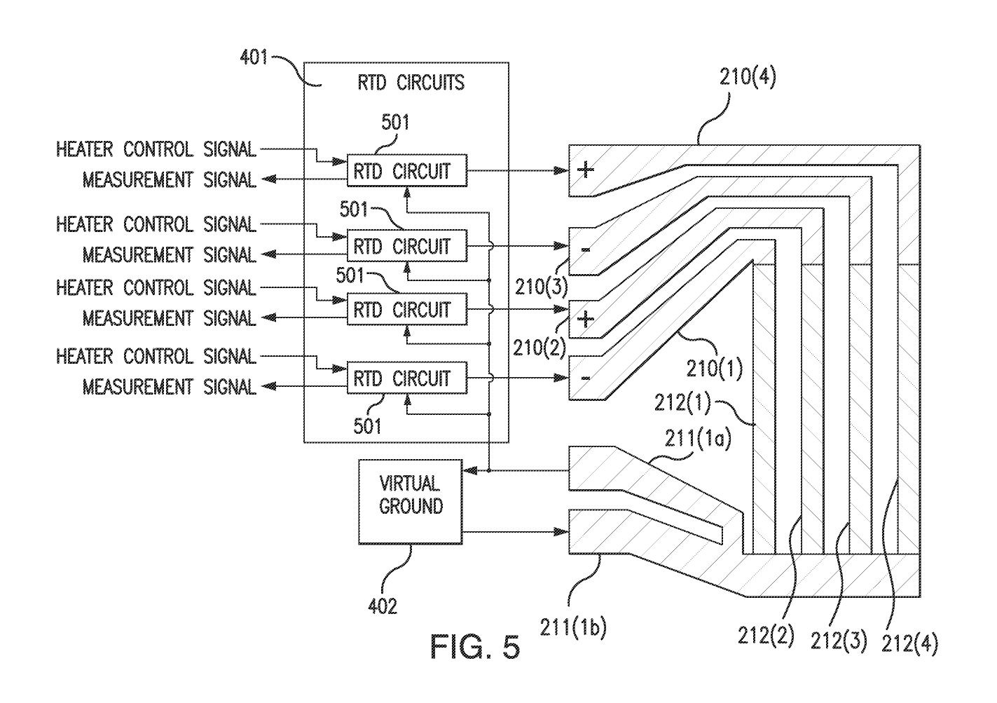

FIG. 5 shows the configuration of a group of RTD control circuits 401 and shows the manner in which one group of RTD control circuits 401 and one virtual ground circuit 402 are connected to the electrodes 210 of a set of multiplexed RTDs 212, in accordance with one embodiment. Specifically, the connections to individual electrodes 210(1)-210(4), first common electrode 211(1a) and second common electrode 211(1b) are shown to provide an illustrative example. Heater control and measurement circuit 104 may be connected to the individual electrodes 210 and common electrodes 211 associated with the other sets of multiplexed RTDs 212 in a similar fashion.

As shown in FIG. 5, a group of RTD circuits 401 includes a plurality of RTD circuits 501. Each RTD circuit 501 is associated with one RTD 212 (e.g., 212(1)) and has an RTD control output connected to the individual electrode 210 (e.g., 210(1)) that is connected to the associated RTD 212. Further, each RTD circuit 501 has an input connected to the first common electrode 211 (e.g., 211(1a)) of the common electrode pair (e.g., 211(1)) connected to the associated RTD 212. The temperature of each RTD 212 is individually controlled and measured by its own RTD circuit 501.

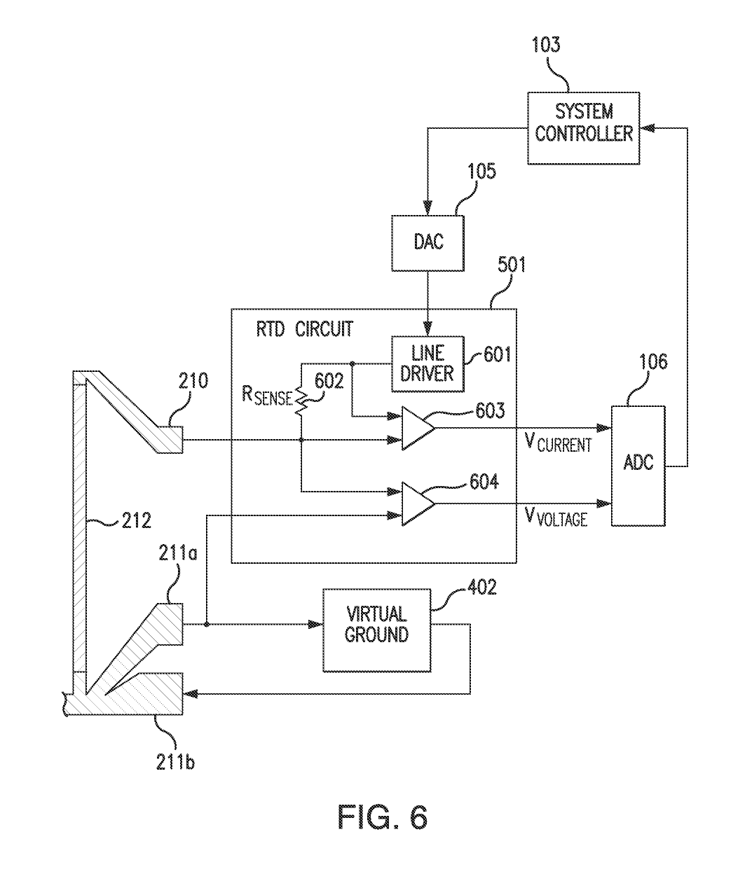

FIG. 6 schematically illustrates the configuration of an RTD circuit 501 used for thermal control of a single thin-film RTD 212, in accordance with one embodiment. The manner in which RTD circuit 501 is connected with the individual electrode 210, first common electrode 211a and second common electrode 211b associated with an RTD 212 are also shown.

As shown in FIG. 6, each RTD circuit 501 comprises a line driver circuit 601, sense resistor 602, and differential amplifiers 603 and 604. Each RTD circuit 501 receives a heater control signal from system controller 103 through DAC 105. Line driver circuit 601 may be either a non-inverting line driver circuit 601 or an inverting line driver circuit 601. Sense resistor 602 is connected in series with RTD 212, and differential amplifier 603 is configured to measure the voltage drop Vcurrent across the sense resistor 602. Because sense resistor 602 is connected in series with an RTD 212, the voltage drop across the sense resistor 602 is indicative of the current across the RTD 212. Differential amplifier 604 is configured to measure the voltage drop Vvoltage across RTD 212. The signals Vcurrent and Vvoltage respectively output from differential amplifiers 603 and 604 are transmitted to system controller 103 through ADC 106.

As stated above, each virtual ground circuit 402 is associated with a pair of common electrodes 211. As shown in FIGS. 5 and 6, according to an embodiment, a virtual ground circuit 402 has an input connected to a first common electrode 211a of the associated pair of common electrodes 211 and an output connected a second common electrode 211b of the associated pair of common electrodes 211.

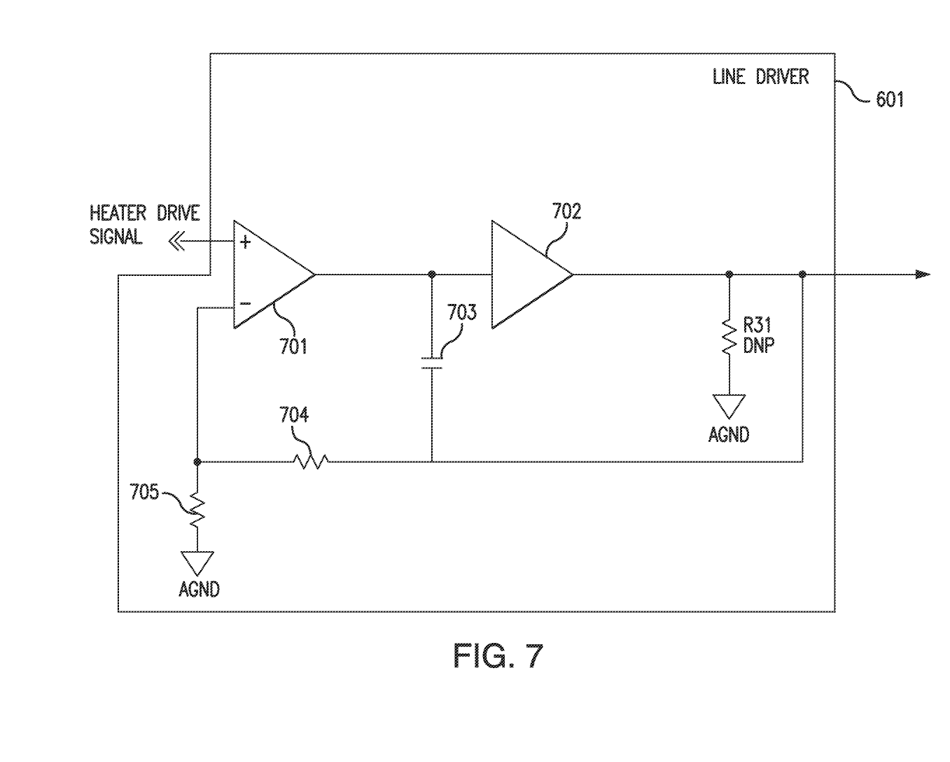

FIG. 7 illustrates the configuration of a non-inverting line driver 601 according to one embodiment. Line driver circuit 601 comprises an operational amplifier 701 followed by a power buffer 702. Line driver circuit 601 additionally comprises capacitor 703 and resistors 704 and 705.

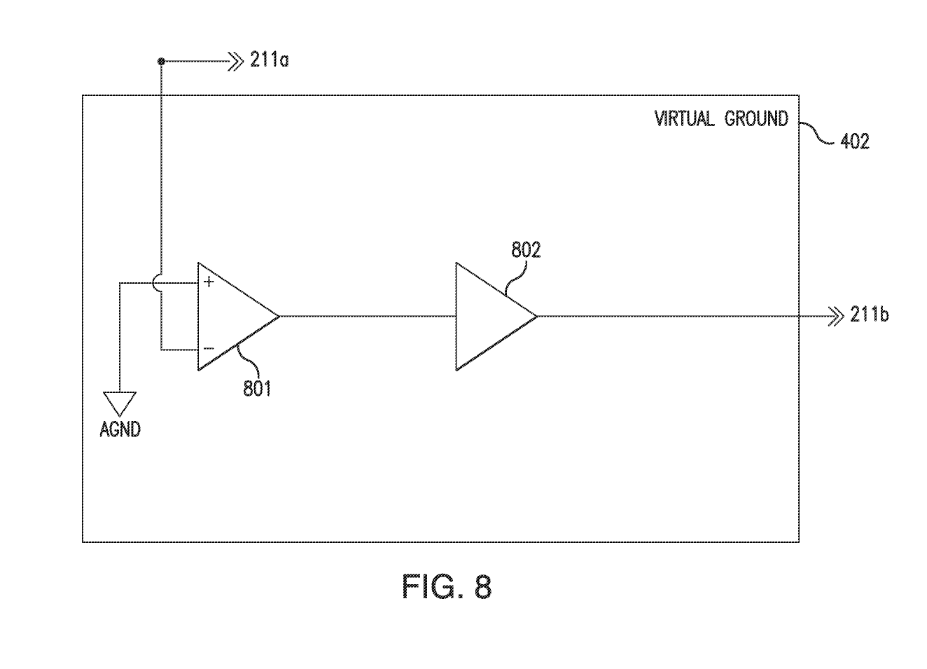

FIG. 8 illustrates the configuration of a virtual ground circuit 402 according to one embodiment. Virtual ground circuit 402 comprises an operational amplifier 801 followed by a power buffer 802. Operational amplifier 801 has a first input connected to a first common electrode 211a and a second input connected to ground. The output of operational amplifier 801 is input into power buffer 802. The output of power buffer 802 is connected to a second common electrode 211b.

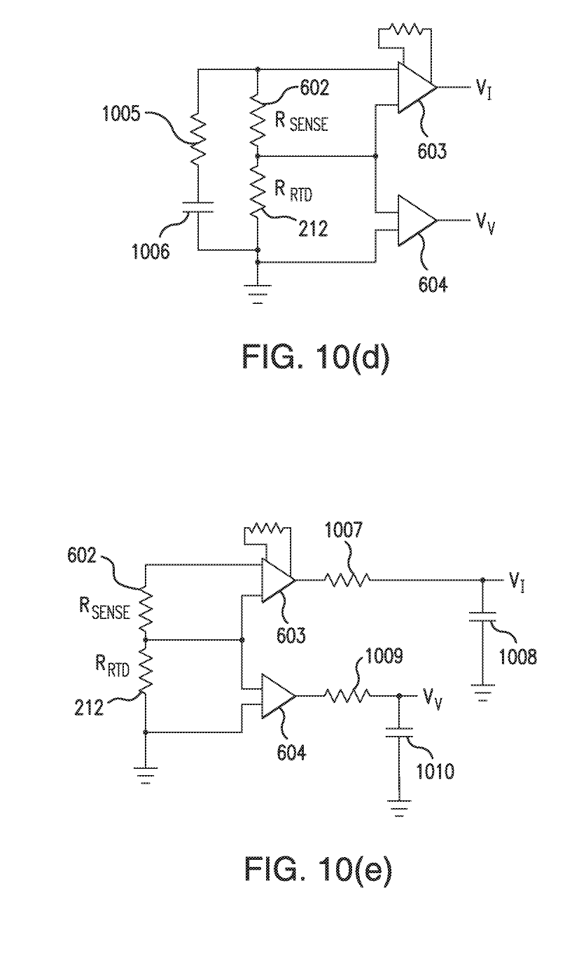

In operation, the thin-film RTDs 212 may be used for temperature sensing as well as rapid heating. System controller 103 may utilize both of these functions to perform high speed closed-loop thermal control of RTDs 212. A flow chart illustrating the closed-loop thermal control according to one embodiment in shown in FIG. 11. At step S1101, system controller 103 outputs initial heater control signals to the RTD circuits 501 of heater control and measurement circuit 104 through DAC 105. System controller 103 may use temperature setpoints output from one or more temperature profiles 1100 to generate the heater control signals. For example, system controller 103 may have a PCR profile for generating heater control signals for RTDs 212 located in PCR thermal zone 204 of microfluidic device 101 and a thermal ramp profile for generating heater control signals for RTDs 212 located in thermal melt zone 206 of microfluidic device 101.

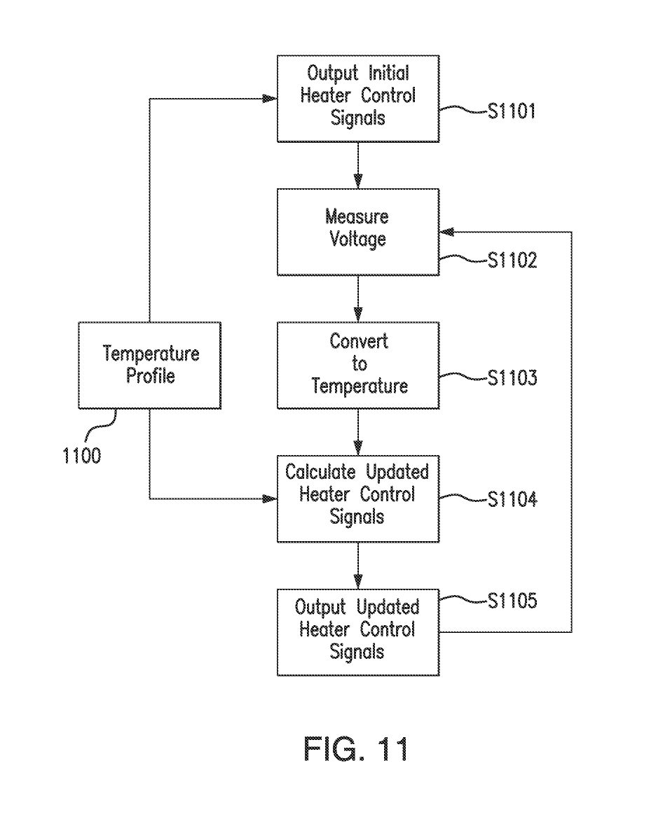

The temperature of each of the RTDs 212 is sensed. Temperature sensing may be achieved by performing steps S1102 and S1103. In step S1102, the currents and voltage drops across each of the RTDs 212 are measured. The currents across each of the RTDs 212 may be measured by using the differential amplifiers 603 of the RTD circuits 501 to detect the voltage drops Vcurrent across the sense resistors 602 connected in series with the RTDs 212. The voltage drops Vvoltage across each of the RTDs 212 may be measured by using the differential amplifiers 604 of the RTD circuits 501 having inputs respectively connected to the individual electrode 210 and first common electrode 211 to which the RTD 212 is connected. In step S1103, the measured currents and voltage drops are converted to temperatures, which may be accomplished using the two-step process shown in FIG. 12.

As shown in FIG. 12, the conversion to temperature may involve steps S1201 and S1202. In step S1201, the resistance of each RTD 212 is determined using the ratio of the measured currents to the measured voltages (i.e., Vvoltage/Vcurrent). In step S1202, the determined resistances of the RTDs 212 are converted to the temperatures of the RTDs 212. The conversion of resistance to temperature may be achieved using a simple mathematic expression or lookup table. Given an RTD 212 with sufficient linearity over the temperatures of interest, one may determine the resistance with just two calibration coefficients (i.e., Temperature=k0+(k1*Resistance)). The specific expression used to determine temperature may be altered by the system designers to give the appropriate level of accuracy for a particular application. Specifically, for example, a quadratic relationship may be appropriate for some materials and applications.

After the temperature of the RTDs 212 has been sensed, in step S1104, system controller 203 calculates updated heater control signals. The updated heater control signals may be calculated using temperature setpoints from one or more temperature profiles 1100, such as the PCR profile and thermal ramp profile described above. In addition, the updated heater control signals may be calculated using proportional-integral-derivative (PID) control (i.e., three-term control). Under PID control, the weighted sum of proportional, integral and derivative values may be used to adjust/update the heater control signals where the proportional value determines the reaction to the current error, the integral value determines the reaction based on the sum of recent errors, and the derivative value determines the reaction based on the rate at which the error has been changing.

In step S1105, the system controller 103 outputs the updated heater control signals to the RTD circuits 501 of heater control and measurement circuit 104 through DAC 105. The process then begins again at step S1102.

The heater driving performed by thermal control circuit 102 of the microfluidic system 100 will now be described. Heating of the thin-film heater/sensor RTDs 212 may be digitally controlled and, in a preferred embodiment, is amplitude modulated. Amplitude modulation is preferred because a continuous modest change in voltage, rather than large voltage steps, avoids slew rate limits and improves settling time. However, since the heater control is digital, various heating schemes are possible and easily implemented. For example, pulse width modulation (PWM) and alternating current (AC) concepts may also be used.

In some embodiments, to heat heater elements 212, system controller 103 outputs a heater control signal that instructs a DAC 105 to output a suitable voltage, whose magnitude is determined by the thermal load. Suitable DACs include multifunction data acquisition (DAQ) devices such as the PXI-6289 from National Instruments, as well as numerous other analog output cards available. Some of the desired characteristics of the DAC include the resolution, absolute accuracy, linearity, response time, and current output capabilities. Specifically, the DAC should have sufficient bit resolution to ensure the desired precision of heating. With too low a resolution for the heater drive signal, the RTD 212 will oscillate around the desired set point. A multifunction DAQ device should address these characteristics as well as have sufficient number of output channels to provide independent control of the multiplexed RTDs 212. Alternatively, system controller 103 could be configured to output digital signals through a digital output device which are interpreted by an integrated circuit that features many DACs 105, such as, for example, the LTC2600 Octal 16-bit rail-to-rail DACs from Linear Technology.

Many otherwise suitable DACs lack sufficient current sourcing capabilities for the desired heating. One specific application where this is of concern is in PCR. The throughput of a PCR platform can be dramatically increased if PCR cycle times are reduced. Having excess heating capability (large current sourcing) can reduce the denature and extension transition times. Furthermore, it allows the system to overcome highly efficient cooling means which are desired for fast annealing but would reduce the heating rate. To improve the current sourcing capabilities, in accordance with one embodiment, a power buffer circuit (i.e., line driver circuit) 601 pre-conditions the DAC signal before it is used by an RTD circuit 501. One such line driver 601 is the combination power buffer 702 with operational amplifier 701 circuit shown in FIG. 7. Operational amplifier 701 may be, for example, Linear Technology Operational Amplifier LT1012. Power buffer 702 may be, for example, Linear Technology Power Buffer LT1010. The desired characteristics of this circuit 601 are the response time, current output capacity, noise, linearity, operating voltage, and absolute accuracy. In a preferred embodiment, power buffer 702 is capable of providing up to 150 mA of current.

It may also be desirable to amplify or attenuate the DAC's signal with the above described line driver circuit 601. For example, with fast PCR it may be desirable to drive the thin-film RTDs 212 with up to 20 V for fast heating. A typical DAC 105 may have insufficient range to achieve this voltage (such as is the case with the PXI-6289 which can output up to plus/minus 10V). In some embodiments (preferred for PCR), the line driver circuit 601 could be configured to provide 2 times gain to the original DAC output. This amplification could be realized with inverting or non-inverting feedback (see FIG. 7) since the DAC 105 is capable of bi-polar output.

In another example, with a smaller thermal load it may be desirable to drive the thin-film RTDs with less than the full range of the DAC 105. In this case, it would be desirable to attenuate the DAC signal before it reaches the thin-film RTD 212. Attenuation allows the entire range of the DAC to be used while driving the load with a lower voltage (resulting in improved resolution of the driving signal and a smoother temperature with less oscillation). The line driver circuit 601 could be used to attenuate the DAC signal by adding a voltage divider between the DAC and the power buffer, or alternatively, the line driver circuit 601 could feature inverting feedback with gain less than 1. A line driver circuit 601 with inverting feedback that attenuates the DAC signal by a factor of 2 is preferred for high resolution thermal melt. Specifically, the preferred embodiments for PCR and thermal melt both include inverting feedback in the line driver circuits 601, which reduces the complexity of the combined system. Further, it may be desirable for the amplification and attenuation circuits to include programmable resistances such as digital potentiometers or DACs that could alter the gain/attenuation at the direction of the system controller 103. The variable gain/attenuation circuits may be useful for a system and sensor controller that operate on different types of microfluidic devices 101 or are required to run different thermal protocols.

Further, in accordance with one preferred embodiment, the thermal control circuit 102 is configured for bi-polar driving potential. This can be achieved through digital control of bi-polar DACs 105, or alternatively, the output of uni-polar DACs 105 could be inverted with the circuitry of line driver circuit 601. The bi-polar driving potential or alternating polarity of the heater driving signals functions in concert with the virtual grounding circuits 402, which are described in further detail below.

In FIGS. 2, 4 and 5, the individual electrodes 210 have been labeled with pluses (+) and minuses (−) to illustrate the alternating polarity of the heater drive signals with which the RTDs 212 may be driven, in accordance with one embodiment. Individual electrodes 210 driven with heater driving signals having a positive polarity are not structurally different from individual electrodes 210 driven with heater driving signals having a negative polarity. The pluses (+) and minuses (−) with which the individual electrodes 210 have been labeled merely provide an illustrative example of the bi-polar driving of RTDs 212. Further, the specific manner with which RTDs 212 have been labeled in FIGS. 2, 4 and 5 is not limiting. For example, RTDs 212(1)-212(8) and/or RTDs 212(9)-212(16) could be driven with polarities opposite than the polarities shown in FIG. 2. Alternating the polarities of the heater drive signals in combination with the virtual grounding of the common electrodes 211 reduces the current density in and temperature of the common electrodes 211 compared to uni-polar driving in which all RTDs are driven with heater driving signals have the same polarity.

The virtual ground circuit 402 shown in FIG. 8, in accordance with one embodiment, works in conjunction with the alternating polarity of the heater driving signals to reduce the current in the pairs of common electrodes 211. Minimizing the current in the pairs of common electrodes 211 decreases waste heat, which is advantageous from a system level and improves the thermal isolation of microfluidic functional zones 204 and 206 in which, for example, PCR and high resolution thermal melt are performed. Furthermore, decreasing the unwanted heating of the common electrodes 211 improves the specificity of the temperature measurement because, for example, at least one of the common electrodes 211 must be used for temperature measurement.

In accordance with embodiments, the function of the virtual ground circuit 402 is to utilize a pair of common electrodes 211 to drive those common electrodes to near zero potential. Further, in some embodiments, nearly all of the current in the pair of common electrodes 211 is contained in one of the common electrodes 211 (e.g., second common electrode 211b), leaving the other common electrode 211 (e.g., first common electrode 211a) available for temperature sensing as will be described in further detail below.

In one embodiment, a virtual grounding circuit 402 is implemented for each pair of common electrodes 211 (i.e., one virtual ground circuit 402 for each multiplexed set of RTDs 212). As described above, the number of RTDs sharing a pair of common electrodes 211 may be chosen for the specific application. However, in some embodiments, it is desirable to consider the current imbalance that may result. If all of the multiplexed RTDs 212 were driven with the same polarity potential, then a large current would flow through one of the common leads 211 (e.g., second common electrode 211b). In contrast, with bi-polar driving signals, any current imbalance will be much smaller. Specifically, positive driving signals tend to cancel out negative ones. A small current imbalance may still exist due to imperfections in the thin-film RTDs 212, differences in RTD layout, or non-uniformity of cooling. In some embodiments, the preferred condition would be a symmetric layout in which polarities alternated for each RTD (e.g., positive/negative/positive/negative). If true symmetry were achieved, there would be no current imbalance and nearly no current in the common electrodes 211.

Further, in some embodiments, the virtual grounding circuit 402 may be capable of sourcing/sinking a resulting current imbalance. In an embodiment, operational amplifier 801 may be, for example, Linear Technology Operational Amplifier LT1012, and power buffer 802 may be, for example, Linear Technology Power Buffer LT1010. In one preferred embodiment, the power buffer 802 is capable of providing up to 150 mA of current.

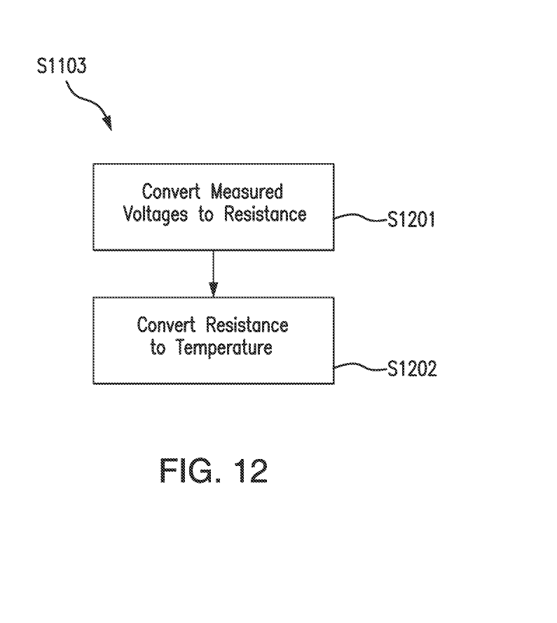

The following non-limiting example describes how a small current imbalance may result in a pair of common electrodes 211 in the microfluidic system 100 shown in FIG. 1 and how this current imbalance may be offset. In the example, heater driving signals having an alternating polarity were used to drive RTDs 212(1)-212(8) of the microfluidic device 101 shown in FIG. 2. Positive drive voltages were used with odd RTDs 212 (e.g., 212(1), 212(3), 212(5) and 212(7)) and negative voltages were used with even RTDs 212 (e.g., 212(2), 212(4), 212(6) and 212(8)). RTDs 212(1)-212(8) were each heated to 70° C. Due to the symmetric nature of the device, the absolute currents required to heat each RTD 212 to 70° C. exhibited a symmetric profile, as shown in FIG. 13. Because outside RTDs 212(1) and 212(8) heat the boundaries, outside RTDs 212(1) and 212(8) may require significantly more power than RTDs 212(2)-212(7). As RTDs 212(1)-212(4) share a pair of common electrodes 211(1a) and 211(1b), a small current imbalance is preferably sourced/sinked by the virtual ground circuit 402 associated with common electrodes 211(1a) and 211(1b). In this case, the virtual ground circuit 402 associated with common electrodes 211(1a) and 211(1b) supplies about −20 mA. Similarly, as RTDs 212(5)-212(8) share a pair of common electrodes 211(2a) and 211(2b), a small current imbalance is preferably sourced/sinked by the virtual ground circuit 402 associated with common electrodes 211(2a) and 211(2b). In this case, the virtual ground circuit 402 associated with common electrodes 211(2a) and 211(2b) supplies about +20 mA.

To sense the temperature of the RTDs 212, each RTD 212 is measured individually by measuring the current and voltage drop across the RTD 212. The current is measured using a precise sense resistor 602 that is placed in series with the RTD 212, as is shown in FIG. 6. An example of a suitable sense resistor 602 is the LVS3 0.5 ohm 15 ppm wire wound surface mount resistor from Precision Resistor Co., Inc. Alternatively, and preferably, the sense resistor 602 may be a film resistor such as Y16070R50000F9W from Vishay Precision Group. Desired characteristics of the current sense resistor 602 are high precision and low temperature coefficient of resistance. In preferred embodiments, care should be taken in the layout of the heater control and measurement circuit 104 to ensure that the sense resistor 602 is in a consistent thermal environment and free from electro-magnetic interference. Furthermore, the resistance of the sense resistor 602 should be large enough to provide a suitable signal but not too large as to decrease the ability of the circuit to rapidly heat the RTDs 212. As such, it is preferable to condition the current sense signal.

To improve the signal to noise ratio (SNR), the differential amplifier 603 that determines the voltage drop Vcurrent across the current sense resistor 602 may be an instrumentation amplifier, such as, for example, the LT1167 from Linear Technologies. Characteristics of a preferred embodiment of the differential amplifier 603 include its accuracy, response time, and operating voltage limits. The differential amplifier 603 may include gain to improve SNR. Specifically, the gain should be sufficient to utilize the entire range of the ADCs 106, which is typically a range such as −10 to 10 Volts. It may be preferable for the gain of the differential amplifier 603 to be programmable by using a digital potentiometer or DAC for the gain resistor. The system controller 103 could then program the variable gain resistor to improve the SNR. Some applications of this include a system and sensor controller 103 that can operate different types of microfluidic devices 101 that feature different resistances or are used at different temperatures or in different thermal environments. Alternatively, the ADC 106 could be chosen to include variable range such as with the PXI-6289 multifunction DAQ, which can operate at ranges as small as plus/minus 1 V and as high as plus/minus 10 V. In this configuration, the range of the ADC 106 would be set as required by the application.

A measure of the voltage drop Vvoltage across the RTD 212 is also required to determine the RTD resistance. The differential amplifier 604 that determines the voltage drop Vvoltage across the RTD 212 may be an instrumentation amplifier, such as the LT1167 from Linear Technologies. Because the common electrode 211 that is connected to the input of the virtual ground circuit 402 passes little to no current, it is preferable to measure the RTD voltage drop Vvoltage as referenced to this common electrode 211. As shown in FIGS. 5 and 6, the first common electrode 211a is the common electrode 211 connected to the input of the virtual ground circuit 402.

In one embodiment, the system controller 103 is configured to have a minimum voltage limit for the heater/sensor driving signal. Specifically, it is desirable for the output of DAC 105 to be maintained at least a minimum DAC output. If the DAC output were allowed to go to zero (or below some pre-determined threshold), in some embodiments, there would be no voltage or current to sense and the system controller 103 would be blind to the true temperature of the RTDs 212. Care should be taken to ensure that the minimum voltage limit is not too high, as this could prevent the RTD from cooling rapidly. Furthermore, if the minimum voltage limit is sufficiently high, the RTDs 212 may not cool to a low desired temperature. In some embodiments, a minimum voltage limit of 400 mV may be appropriate, but the limit may vary based on circuit components, desired accuracy, and thermal profile required.

Cabling connecting the RTDs to the heating control and measurement circuit 104 of the thermal control circuit 102 may be designed to reduce any corruption of the precise temperature measurement signal. Preferably, the cabling is low resistance, protected from electro-magnetic noise (shielded, twisted, etc.), and thermally stable (including having a low temperature coefficient of resistance). Furthermore, it may be preferred that the sensor cable be wired for 4-wire resistance measurement to mitigate adverse cable effects such as the sensitivity of the cable resistance to temperature. Since the common electrodes 211 are already paired, only 1 additional wire is required for each sensor to yield 4-wire measurements.

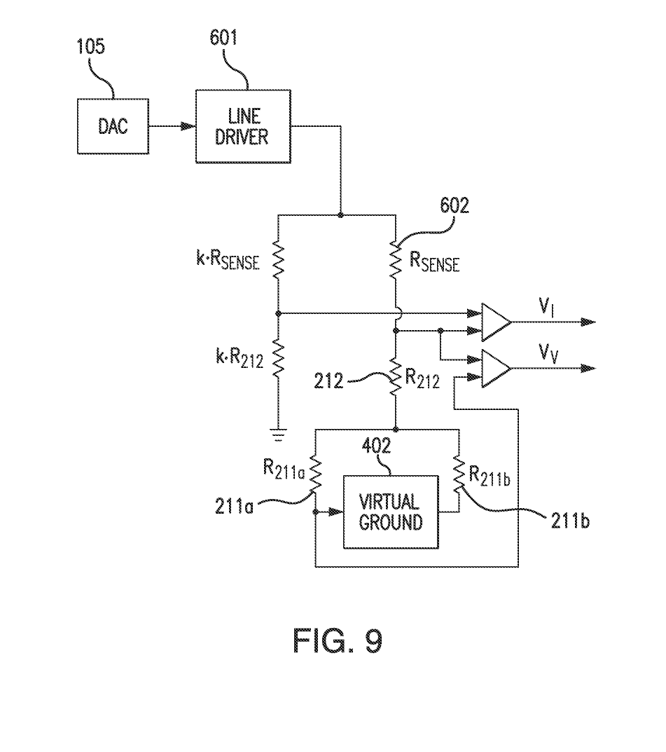

Some alternative circuit configurations may improve SNR. For example, one embodiment to improve SNR is to use a bridge configuration to remove the common mode voltage from the current sensing signal. This alternative circuit configuration is shown in FIG. 9. In this embodiment, a voltage divider with approximately the same ratio as the sense resistor 602 to the associated RTD 212 is formed. The reference voltage divider is insensitive to temperature because the scaling factor, k, is large (e.g., 100) to ensure low Joule heating. Thus, the reference voltage divider forms a stable reference voltage and improves the SNR of the current sensing signal Vcurrent (shown in FIG. 9 as V_{I}).

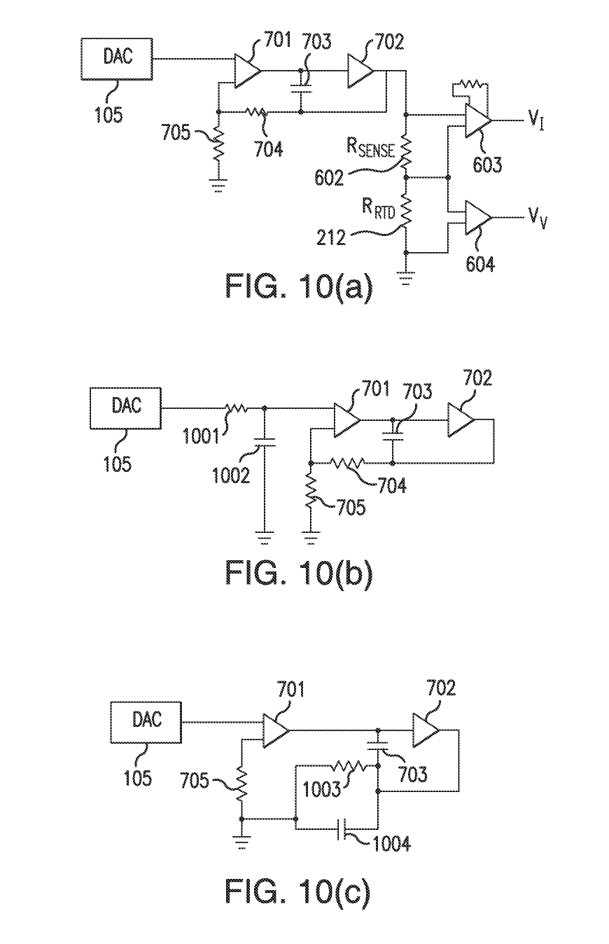

Further, it may be desirable to use certain low-pass filtering components to condition the heater drive signals and current and voltage measurement signals. FIG. 10(a) illustrates the configuration of the RTD circuit 501 shown in FIGS. 5 and 6 along with its connections with DAC 105 and RTD 212. Alternative circuit configurations utilizing low-pass filtering components are shown in FIGS. 10(b)-10(e). FIG. 10(b) illustrates a pre-filter power buffer configuration in which resistor 1001 and capacitor 1002 have been added between DAC 105 and line driver circuit 601. FIG. 10(c) illustrates a filter power buffer feedback configuration in which resistor 1003 and capacitor 1004 have been added to the configuration of line driver circuit 601. FIG. 10(d) illustrates a parallel low-pass filter configuration in which resistor 1005 and capacitor 1006 have been added in parallel to the sense resistor 602 and RTD 212 series. FIG. 10(e) illustrates a low-pass filter output configuration in which resistor 1007 and capacitor 1008 have been added at the output of differential amplifier 603 and in which resistor 1009 and capacitor 1010 have been added at the output of differential amplifier 604. In these configurations, the cut-off frequencies would be chosen to eliminate unwanted noise while preserving the ability to provide rapid closed-loop thermal control.

Another feature of some embodiments of the present invention is that the digitization of data and digital closed-loop control allow for the development of sophisticated digital algorithms. One such algorithm may be used to correct for the parasitic resistances which exist between the multiplexed RTDs 212. For instance, an electrical model may be used to solve the resistance network while accounting for the coupling caused by the parasitic resistances. Further, the system controller 103 may be configured to first measure the sheet resistance of the lead layer using the pair of common electrodes. Then, the sheet resistance of the lead layer could be used as an input into the above mentioned electrical model.

In addition, it is not necessary the driving source be based on direct current (DC). The driving source may instead be based on alternating current (AC). Thus, according to one embodiment of the present invention, the amount of heat delivered to the device may be controlled through amplitude modulation, the alternating polarity concepts described above may be used to minimize waste heat and deliver excellent temperature measurements, and the driving source may be based on AC.

It may be desirable to drive with AC rather than DC for a variety of reasons, which may include but are not limited to reducing power consumption or reducing the potential for electrolysis due to current leakage into a fluid filled microchannel 202. The electrolysis of water can be a problem in microfluidic systems as the gases that are formed can result in bubbles that block the microchannel 202 and prevent fluid flow. The use of high frequency (e.g., >1 kHz) can reduce or eliminate the formation of bubbles while allowing the high root-mean-square (RMS) potential required for the desired heating.

In some embodiments, the AC heater driving signal may be any suitable waveform. Examples include sine, square, saw-tooth, and triangle waveforms. All of the methods described above about amplitude modulation and alternating polarity are applicable to AC heater driving signals. By driving alternating channels with signals that are 180 degrees out of phase, the benefits of the alternating polarity concept are retained. The phase shift can be realized through software that drives the DACs 105 or through hardware (e.g. including inverters on some channels). One consideration in such a system is the fast response of the amplifiers used.

In another aspect, the alternating polarity concept could be used to minimize waste heat and deliver high quality temperature measurements without using the RTDs 212 as heating elements. This configuration may be desirable if one has a need to determine the temperature on the microfluidic device 101 but has some other means of heating (e.g., when the device is heated by an external means). Using the RTDs 212 as sensors only is easily realized using the techniques described above. In this configuration, a fixed driving potential may be used with no amplitude modulation. This configuration could, optionally, include the bridge configuration shown schematically in FIG. 9.

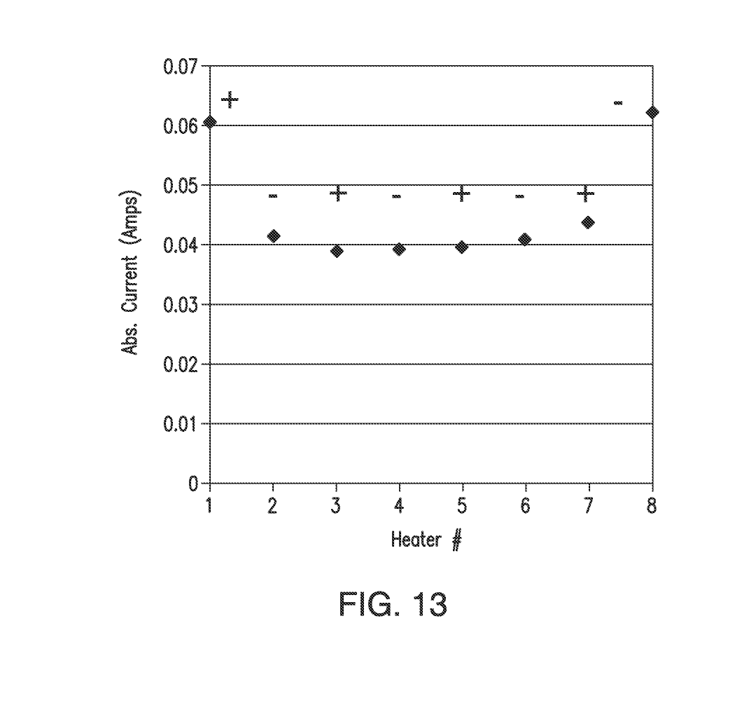

FIG. 14 illustrates one embodiment of a configuration capable of using RTDs 212 for temperature measurement only. The temperature measurement circuit 1401 shown in FIG. 14 may receive a single drive signal used for driving all of the RTDs 212. The alternating polarity may be achieved by running the drive signal for the odd RTDs 212 (e.g., RTDs 212(1), 212(3) etc.) through an inverting line driver 601 while running the drive signal for the even RTDs 212 (e.g., RTDs 212(2), 212(4) etc.) through a non-inverting line driver 601. Measurement circuit 1401 may use a bridge configuration to form reference voltage dividers. The fixed driving potential of the driving signal is preferably small to minimize self-heating and could be generated by a multifunction DAQ device such as, for example, PXI-6289, a voltage reference IC such as, for example, MAXIM's MAX6138, or a zener diode. Moreover, only 1 measurement per channel is required to determine temperature in this system because the driving potential is fixed.

In some embodiments, as described above, two or more resistive sensors 212 may be connected together via one or more common electrodes. For example, in one illustrative embodiment, resistive sensors 212(1)-212(4) may be connected together via common electrodes 211(la) and 211(lb) as shown in FIGS. 3 and 5. Connecting two or more resistive sensors 212 via a common electrode may have the unwanted effect of creating an electrical coupling of the resistive sensors 212. The parasitic resistance inherent in the common electrode 211 can result in an imperfect ground. Specifically, the net current of the several electrodes together with the common lead resistance may result in a non-zero reference voltage. However, as described above, this imbalance may be reduced by alternating the polarities of the heater drive signals for the resistive sensors 212. Still, a current imbalance such as that illustrated in FIG. 13 may remain because, in some embodiments, the outer resistive sensors (e.g., resistive sensors 212(1) and 212(8)) may carry a higher current due to their need to heat the boundaries of the heated zone (e.g., PCR thermal zone 204). This current imbalance may result in a small unwanted error in the measurements. Accordingly, some embodiments may further reduce this current imbalance (and enable more accurate measurements) by combining thermal guard heaters with the alternating polarity method for driving the multiplexed resistive sensors 212. In some embodiments, the thermal guard heaters may improve (i) the thermal uniformity of the microfluidic system 100 and (ii) the accuracy and control of the resistive sensors 212.

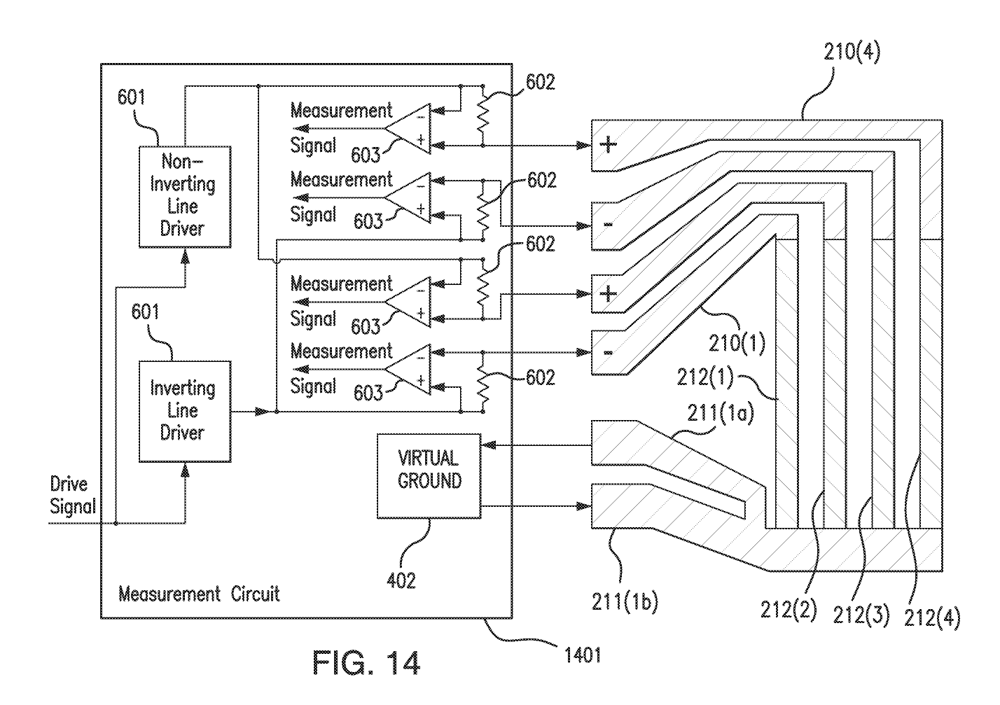

In some embodiments, as described above with reference to FIG. 1, the microfluidic system 100 may include a microfluidic device 101, which may be, for example, as illustrated in FIG. 2. However, this is not required, and, in some alternative embodiments, the microfluidic system 100 may alternatively include a microfluidic device 1500 that includes one or more thermal guard heaters. FIG. 15 illustrates a top view of a non-limiting example of a microfluidic device 1500 including one or more thermal guard heaters 1504 and embodying aspects of the present invention.

In some embodiments, like microfluidic device 101, microfluidic device 1500 may include microfluidic channels 202, inlet ports 203, heated zones 204 and 206, resistive sensors 212 that function as temperature sensors and heaters, and sensor electrodes 210 and 211. Heated zone 204 may be a PCR thermal zone, and heated zone 206 may be a thermal melt zone. The microfluidic channels 202 may extend across a substrate 1501 and through heated zones 204 and 206. In some embodiments, the resistive sensors 212 may be thin film resistive thermal detectors (RTDs). In some embodiments, the resistive sensors 212 may each be associated with (e.g., below or adjacent to) a microfluidic channel 202. For example, in the non-limiting illustrated embodiment, resistive sensors 212(1)-212(8) are each associated with a respective microfluidic channel 202 in the PCR thermal zone 204, and resistive sensors 212(9)-212(16) are each associated with a respective microfluidic channel 202 in the thermal melt zone 206.

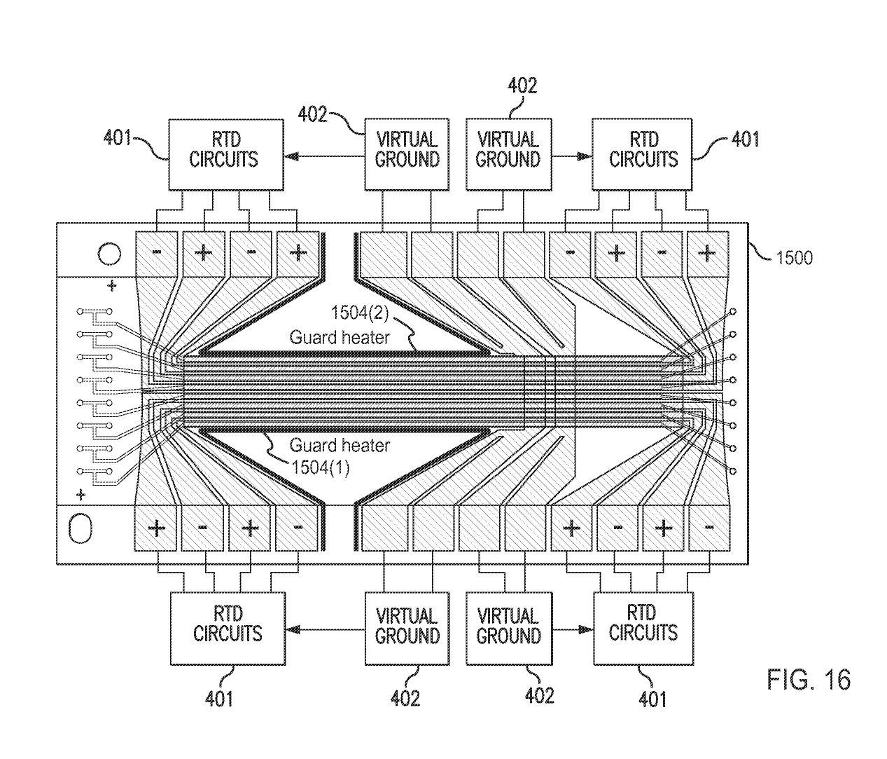

In some non-limiting embodiments, sensor electrodes 210 and 211 provide electrical power to the resistive sensors 212. To utilize the limited space provided by substrate 1501 of microfluidic device 1500 and reduce the number of electrical connections required, multiple sensors 212 may share one or more common electrodes 211. Sensor electrodes 210 and 211 include individual electrodes 210 and common electrodes 211. In the embodiment illustrated in FIG. 15, multiple sensors 212 may share one common electrode 211 (e.g., resistive sensors 212(1)-212(4) share common electrode 211(1)), but this is not required. In some alternative embodiments, multiple sensors 212 may share a pair of common electrodes (see, e.g., first common electrode 211(1a) and second common electrode 211(1b) of FIG. 2). For example, as illustrated in FIG. 17, resistive sensors 212(1)-212(4) may share a pair of common electrodes 211(1a) and 211(1b). The pairs of common electrodes 211 allow the microfluidic sensors to be controlled in three-wire mode.

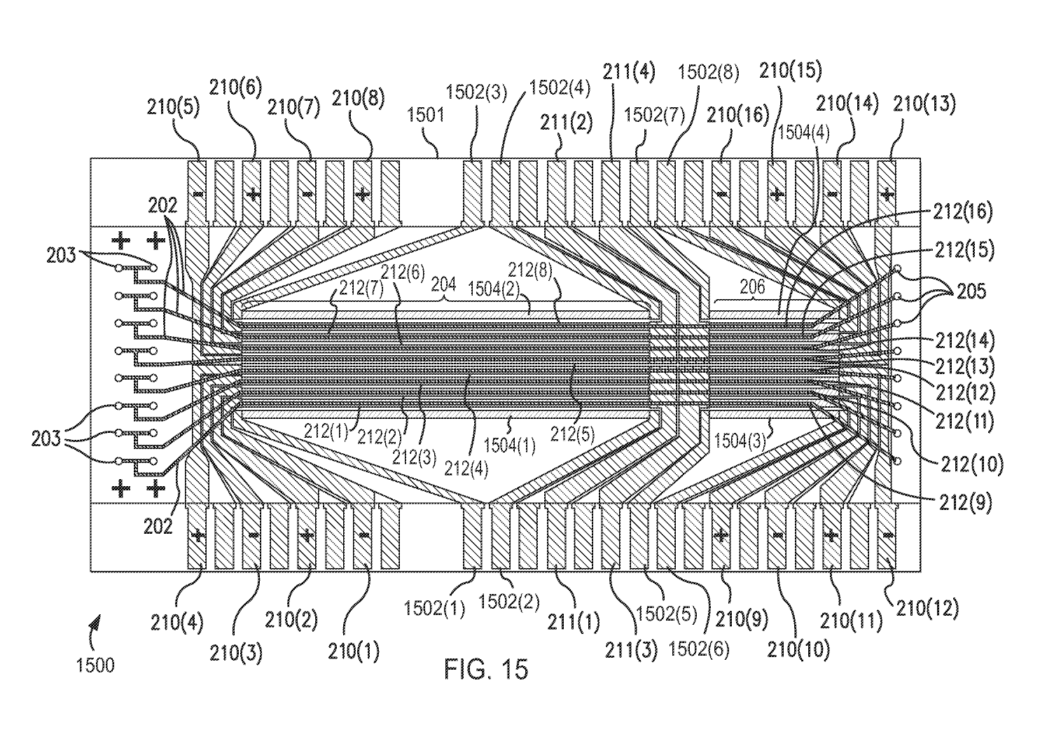

In the non-limiting embodiment illustrated in FIG. 15, there are sixteen resistive sensors 212(1)-212(16), sixteen individual electrodes 210(1)-210(16), and four common electrodes 211(1)-211(4). However, as noted above, in some non-limiting embodiments, each common electrode may be a pair of common electrodes 211a and 211b (see FIGS. 16-18). Each resistive sensor 212 may be connected to an individual electrode 210 and one or more common electrodes 211. Multiple resistive sensors 212 may share one or more common electrodes 211 and are thereby multiplexed with the one or more common electrodes 211. For example, resistive sensor 212(1) may be connected to individual electrode 210(1) and common electrode 211(1) as illustrated in FIG. 15 (or common electrodes 211(1a) and 211(1b) as illustrated in FIG. 17). FIG. 3 illustrates a thin-film resistance network associated with the sensor electrodes 212 and electrodes 210 and 211 in an embodiment of the microfluidic device 1500 having pairs of common electrodes 211(a) and 211(b).

Although the microfluidic device 1500 shown in FIG. 15 has four resistive sensors 212 connected to each of the four common electrodes 211, more or fewer resistive sensors may be multiplexed with each common electrode 211. Furthermore, more or fewer common electrodes 211 (or pairs of common electrodes 211a and 211b) may be used to create more or fewer multiplexed sets of resistive sensors.

In some embodiments, each of the resistive sensors 212 of the microfluidic device 1500 may be independently controlled for rapid heating and temperature sensing. As a result, the temperature of a microfluidic channel 202 in PCR thermal zone 204 may be controlled independently of the temperature of the microfluidic channel 202 in thermal melt zone 206. Also, the temperature of each microfluidic channel 202 in a heated zone 204 or 206 may be controlled independently of the temperature of the other microfluidic channels 202 in the heated zone 204 or 206.

In some embodiments, the microfluidic device 1500 may be a substantially planar device and may have large temperature gradients in the planar axes because the areas outside the heated zones 204 and 206 may function as a large thermal sink. The microfluidic device 1500 may include one or more thermal guard heaters 1504, which may improve the thermal uniformity of the microfluidic device 1500 by mitigating conduction by the substrate 1501. In some embodiments, the one or more thermal guard heaters 1504 may be located on one or more thermal boundaries of one or more of the heated zones 204 and 206, and the one or more thermal guard heaters 1504 may heat the thermal boundaries. In some non-limiting embodiments, one or more thermal guard heaters 1504 may be located on the thermal boundaries of each of heated zones 204 and 206.

In the embodiment illustrated in FIG. 15, thermal guard heaters 1504(1) and 1504(2) are located on portions of the thermal boundaries of the PCR thermal zone 204, and thermal guard heaters 1504(3) and 1504(4) are located on portions of the thermal boundaries of the thermal melt zone 206. However, this is not required, and, in alternative embodiments, the microfluidic device 1500 may include more or fewer thermal guard heaters 1504. For example, in some alternative embodiments, the microfluidic device 1500 may include four thermal guard heaters 1504 around the thermal boundaries of each of the rectangular heated zones 204 and 206.

In some embodiments, as illustrated in FIG. 15, one or more of the thermal guard heaters 1504 may be adjacent an outer resistive sensor 212 and may run parallel to the outer resistive sensor 212 along one or more portions of one or more thermal boundaries of a heated zone. For example and without limitation, thermal guard heaters 1504(1)-1504(4) may be adjacent to outer resistive sensors 212(1), 212(8), 212(9), and 212(16), respectively. Thermal guard heaters 1504(1) and 1504(2) may run parallel to outer resistive sensors 212(1) and 212(8) along portions of thermal boundaries of heated zone 204, and thermal guard heaters 1504(3) and 1504(4) may run parallel to outer resistive sensors 212(9) and 212(16) along portions of thermal boundaries of heated zone 206.

In some embodiments, the thermal guard heaters 1504 may be resistive heaters (e.g., thin-film resistive heaters). In some non-limiting embodiments, the thermal guard heaters 1504 may be made from any suitable resistive material capable of being used as a heater (e.g., platinum or nickel). In some embodiments, the thermal guard heaters 1504 and the resistive sensors 212 may be made from the same material, but this is not required, and, in some alternative embodiments, the thermal guard heaters 1504 and the resistive sensors 212 may be made from different materials. In some embodiments, the thermal guard heaters 1504 may function solely to heat the thermal boundaries of the heated zones 204 and 206, but this is not required, and, in some alternative embodiments, the thermal guard heaters 1504 may additionally operate as temperature sensors. In some embodiments, unlike the resistive sensors 212, the thermal guard heaters 1504 may not be associated with a microfluidic channel 202 (e.g., the thermal guard heaters 1504 may not be covered by a microfluidic channel 202).

In some non-limiting embodiments, the microfluidic device 1500 may include guard heater lead wires or electrodes 1502, which may provide electrical power to the thermal guard heaters 1504. In the embodiment illustrated in FIG. 15, guard heater electrodes 1502(1) and 1502(2) may be connected to opposite ends of thermal guard heater 1504(1), guard heater electrodes 1502(3) and 1502(4) may be connected to opposite ends of thermal guard heater 1504(2), guard heater electrodes 1502(5) and 1502(6) may be connected to opposite ends of thermal guard heater 1504(3), and guard heater electrodes 1502(7) and 1502(8) may be connected to opposite ends of thermal guard heater 1504(4). In some embodiments, the guard heater electrodes 1502 may be more conductive than the thermal guard heaters 1504. In some embodiments, the guard heater electrodes 1502 may be any suitable conductive material, such as, for example and without limitation, gold. In some embodiments, the guard heater electrodes 1502 and the sensor electrodes 210 and 211 may be made from the same material, but this is not required, and, in some alternative embodiments, the guard heater electrodes 1502 and the sensor electrodes 210 and 211 may be made from different materials.

In some embodiments, as illustrated in FIG. 15, the thermal guard heaters 1504 are not connected to the common electrodes 211, and, as a result, the thermal guard heaters 1504 are not part of the one or more multiplexed circuits including multiple resistive sensors 212 connected to one or more common electrodes 211. In some embodiments, the one or more thermal guard heaters 1504 correct the current imbalance shown in FIG. 13 in which the outer resistive sensors 212 (e.g., outer resistive sensors 212(1), 212(8), 212(9), and 212(16) of FIG. 15) carry a higher current load by heating one or more portions of the thermal boundaries of one or more of heated zone. In particular, with the thermal guard heaters 1504 heating the thermal boundaries, there may be no need for the outer resistive sensors 212 to carry a higher current load because the outer resistive sensors 212 are effectively interior elements relative to the thermal guard heaters 1504. In some embodiments where the thermal guard heaters 1504 are resistive heaters, the thermal guard heaters 1504 may carry the higher current load instead of the outer resistive sensors 212. However, because the thermal guard heaters 1504 are not part of the multiplex circuit, the higher current load carried by the thermal guard heaters 1504 is irrelevant to the measurements of the multiplexed resistive sensors 212.

FIGS. 16-18 illustrate the configuration of a heater control and measurement circuit 104 that drives the resistive sensors 212 with alternating polarities according to one embodiment in which the microfluidic device 1500 includes guard heater elements 1504. As illustrated in FIGS. 16-18, in some embodiments, the thermal guard heaters 1504 are not connected to a common electrode, and the thermal guard heaters 1504 may be controlled by the thermal control circuit 102. In some embodiments, the thermal guard heaters 1504 may protect only portions of the thermal boundaries of the one or more heated zones.

FIG. 16 illustrates integration of thermal guard heaters 1504(1) and 1504(2) to heat the thermal boundaries of a heated zone of a microfluidic device 1500 having pairs of common electrodes according to one embodiment. Although not illustrated in FIG. 16, the microfluidic device 1500 may additionally include thermal guard heaters to heat the thermal boundaries of the second heated zone (see, e.g., thermal guard heaters 1504(3) and 1504(4) of FIG. 15). FIG. 16 is similar to FIG. 4 but additionally shows thermal guard heaters 1504(1) and 1504(2). FIG. 16 shows the general configuration of heater control and measurement circuit 104 (see FIG. 1) and generally shows the manner in which components of the heater control and measurement circuit 104 may be connected to the electrodes 210 and 211 of microfluidic device 1500. In some embodiments, as shown in FIG. 16, the heater control and measurement circuit 104 may include groups of RTD control circuits 401 and virtual ground circuits 402. Each group of RTD control circuits 401 may be associated with a set of multiplexed resistive sensors 212. Each virtual ground circuit 402 may be associated with one electrode of pair of common electrodes 211. FIG. 5 shows the configuration of a group of RTD control circuits 401 and shows the manner in which one group of RTD control circuits 401 and one virtual ground circuit 402 are connected to the electrodes 210 and 211 of a set of multiplexed resistive sensors 212, in accordance with one embodiment.

FIG. 17 illustrates integration of the thermal guard heater 1504(1) to heat a portion of the thermal boundary of heated zone 204 of a microfluidic device 1500 having pairs of common electrodes according to one embodiment. In some embodiments, as shown in FIG. 17, the thermal guard heater 1504(1) may be driven with a guard heater signal, which may be supplied to the thermal guard heater 1504(1) via one of the two guard heater electrodes 212 (e.g., guard heater electrode 1502(1)) connected at opposite ends of the thermal guard heater 1504(1). In some embodiments, the other of the two guard heater electrodes 212 (e.g., guard heater electrode 1502(2)) connected at opposite ends of the thermal guard heater 1504(1) may be connected to ground.

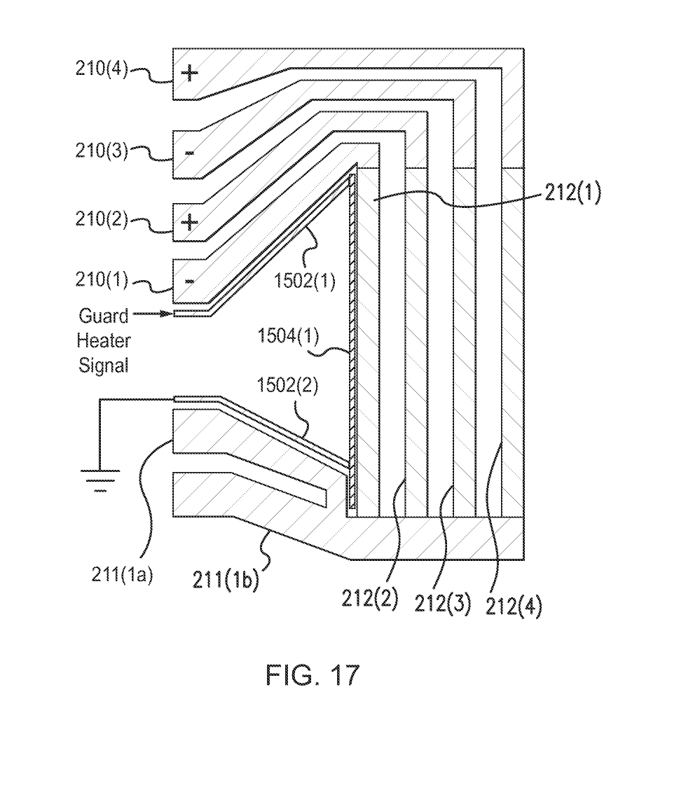

FIG. 18 is similar to FIG. 6 and schematically illustrates the configuration of an RTD circuit 501 used for thermal control of a single resistive sensor 212 and the manner in which RTD circuit 501 is connected with the individual electrode 210, first common electrode 211a, second common electrode 211b, and virtual ground 402 associated with the resistive sensor 212, in accordance with one embodiment. FIG. 18 also schematically illustrates the configuration of a guard heater circuit 1801 used for thermal control of a single thermal guard heater 1504, in accordance with one embodiment. In some embodiments, there may be one guard heater circuit 1801 for each thermal guard heater 1504.

As shown in FIG. 18, each guard heater circuit 1801 may include a line driver circuit 1804, sense resistor 1802, and differential amplifier 1803. Each guard heater circuit 1801 may receive a guard heater signal from the system controller 103 through DAC 1805. Line driver circuit 1804 may be either a non-inverting line driver circuit 1804 (see FIG. 7) or an inverting line driver circuit 1804. Sense resistor 1802 is connected in series with thermal guard heater 1504, and differential amplifier 1803 is configured to measure the voltage drop Vcurrent across the sense resistor 1802. Because sense resistor 1802 is connected in series with a thermal guard heater 1504, the voltage drop across the sense resistor 1802 is indicative of the current across the thermal guard heater 1504. Differential amplifier 1803 is configured to measure the voltage drop Vcurrent across the sense resistor 1802. The signal Vcurrent output from the differential amplifier 1803 may be transmitted to system controller 103 through ADC 106. Although some embodiments of the guard heater circuit 1801 may include a sense resistor 1802 and a differential amplifier 1803, this is not required. In some alternative embodiments (e.g., embodiments where the thermal guard heater drive signal may be proportional to the heater control signal used to drive the adjacent resistive sensor 212 as described below), the guard heater circuit 1801 may not include a sense resistor 1802 and a differential amplifier 1803.

In some embodiments, the heater control signal used to drive the resistive sensor 212 adjacent to the thermal guard heater 1504 may be used as a control signal to determine the appropriate guard heater signal to drive the thermal guard heater 1504. For example, the heater control signal used to drive the resistive sensor 212(1) adjacent to the thermal guard heater 1504(1) may be used as a control signal to determine the appropriate guard heater signal to drive the thermal guard heater 1504(1). Similarly, the heater control signals used to drive the resistive sensors 212(8), 212(9), and 212(16) may be used as control signals to determine the appropriate guard heater signal to drive the thermal guard heaters 1504(2)-1504(4), respectively.

In some embodiments, the one or more thermal guard heaters 1504 may be driven at the same polarity as the polarity of the adjacent sensor's drive signal. However, this is not required, and, in some alternative embodiments, the one or more thermal guard heaters 1504 may be driven with a polarity opposite the polarity of the adjacent sensor's drive signal.

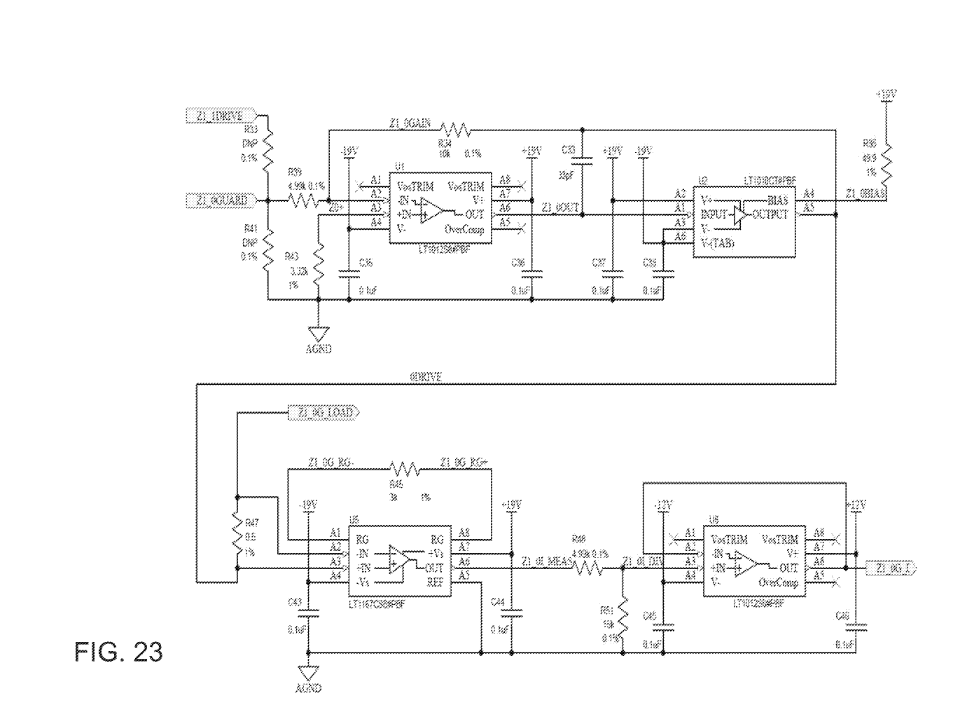

In some non-limiting embodiments, the thermal guard heater drive signal may be proportional to the heater control signal used to drive the adjacent resistive sensor 212 (i.e., the guard heater drive signal may be some constant times the adjacent sensor's drive signal). For example and without limitation, in some embodiments, a thermal guard heater 1504 may be driven with a voltage that is the voltage at which the adjacent sensor 212 is driven multiplied by a constant (e.g., 0.5, 1, 1.5, 2, or 2.5). In some non-limiting embodiments, the constant may be within a range greater than or equal to 0.5 and less than or equal to 3, and this range should be understood as describing and disclosing all numbers (including all decimal or fractional numbers) within this range. In some non-limiting embodiments, the constant may be within a range greater than or equal to 1 and less than or equal to 2, and this range should be understood as describing and disclosing all numbers (including all decimal or fractional numbers) within this range. In some non-limiting embodiments, the proportional thermal guard heater drive signals may be achieved by (a) using system controller 103 and varying the drive signals via the DACs or (b) using straight-forward analog circuits (e.g., connecting the drive signal for the adjacent sensor 212 to both (i) the individual electrode 210 for the adjacent sensor 212 and (ii) an electrode 1502 for the thermal guard (possibly with appropriate amplification). In some non-limiting embodiments, the system controller 103 may determine the appropriate drive signals for the multiplexed resistive sensors 212 as well as the thermal guard heaters 1504 using the temperature measurements determined in steps S1102 and S1103 of FIG. 11. In some embodiments, the thermal control using proportional thermal guard heater drive signals may be carried out using the updated heater control signals output for the adjacent resistive sensors in step S1105 of FIG. 11 to determine the thermal guard heater drive signals. FIG. 23 is a schematic diagram illustrating one non-limiting example of a thermal guard heater driving circuit using proportional thermal guard heater drive signals as implemented on a heater control board (e.g., a DE-195002-0008 heater control board).

Although some embodiments use the proportional thermal guard heater drive signals described above, this is not required. In some alternative embodiments, the thermal guard heaters 1504 may also function as temperature sensors, and drive signals for the thermal guard heaters 1504 may be determined based on temperature measurements of the thermal guard heaters 1504 (see the description of FIG. 11 above regarding the voltage measurements, conversion to temperature measurements, and the calculation of updated drive signals). In these alternative embodiments, the system controller 103 may use PID or known means to provide closed-loop feedback control for the thermal guard heaters 1504.

In some non-limiting embodiments, the thermal guard heaters 1504 may be used to correct a current imbalance in a circuit containing a split common electrode (i.e., a pair of common electrodes 211a and 211b as shown in FIGS. 2-6 and 16-18). In some embodiments, the thermal guard heaters 1504 may allow the terminal connecting the two branches of the common electrode 211 to be moved further from the multiplexed sensor 212. Because the current imbalance is negligible when the guards 1504 are used, there is little voltage drop in the un-split portion of the common electrode 211. This may be advantageous for closely packed circuits that are often desirable in microsystems and microfluidics.

Experimental results show that, in some embodiments, use of the thermal guard heaters 1504 decreased the melt temperature (Tm) standard deviation from an average of 0.10° C. to an average standard deviation of 0.067° C. (values based on 11 cartridges with unguarded sensors and 16 cartridges with guarded sensors). In addition to improving Tm variance, use of the thermal guard heaters 1504 may improve controllability and unwanted heater oscillations and may reduce the need to produce microfluidic chips with low lead sheet resistance.

In addition, an experiment was designed to provide a direct measurement of the guarded effect by using different guard heater drive currents in a series of melts with the same cartridge. A mixture of off-chip produced amplicon with well-known melting characteristics (RFCal) was used. The RFCal is a mixture of two different amplicons (RF100 and RF200) and produces two distinct melt domains used for thermal calibration of the sensors.

In each case, the sensors were calibrated using an RFCal melt (50-105° C./s at 0.5° C./s). Once the calibration coefficients were determined, a “check” melt (65-95° C./s at 0.5° C./s) was used to determine the precision of the calibration. The cartridge was then reset, by flushing it out with RFCal and restarting the software (this time with a different guard heater drive ratio).

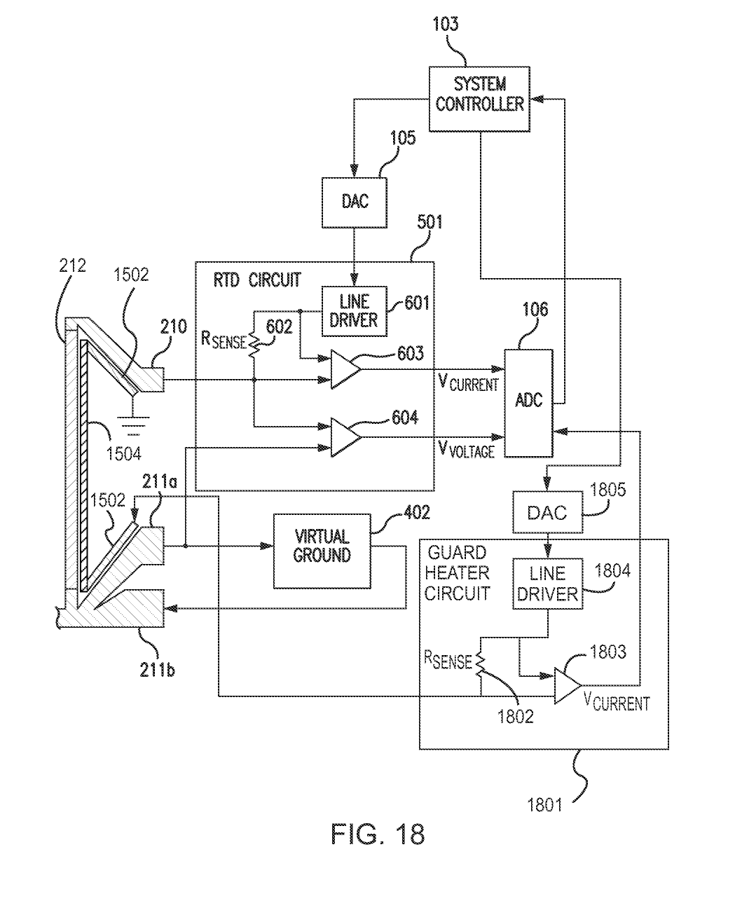

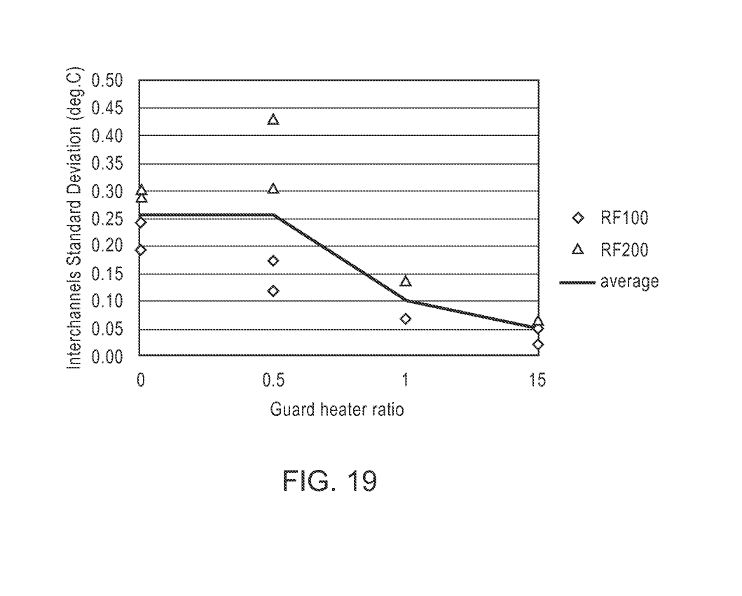

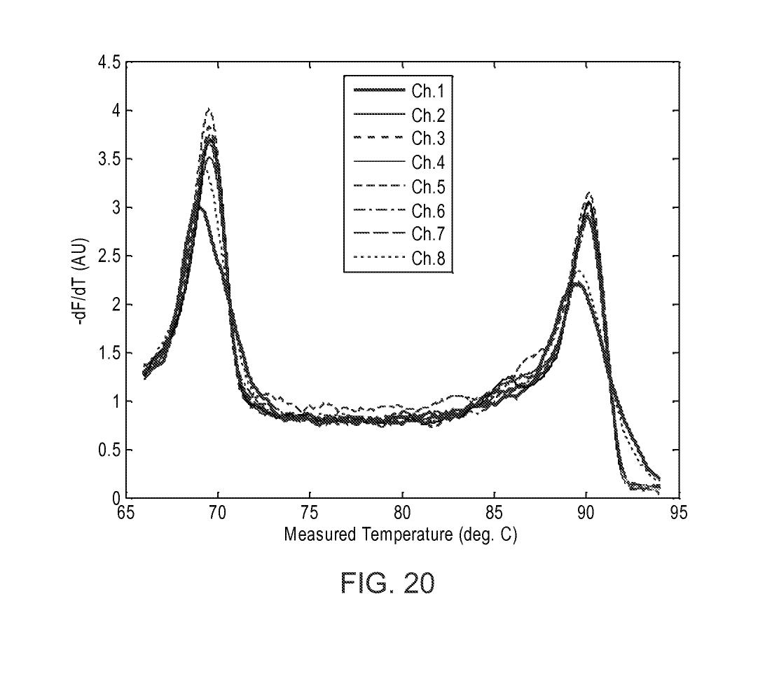

The guard ratios were tested in an order designed to remove any time dependent effect. A thermal guard ratio of 1.5 resulted in excellent Tm standard deviations (0.05° C.) in comparison to the Tm standard deviation with the guards off (0.26° C.). Intermediate performance was observed with guard ratios (e.g., 0.5 and 1.0) that only provided a partial thermal guard. By changing the guard ratios back and forth between good values and less good values, the Tm standard deviations were observed to improve/degrade as theory would suggest. FIG. 19 is a graph illustrating interchannel standard deviation in Tm, as determined based on peak picking a Savitzky-Golay filtered (2 deg. C window) negative derivative curve. FIGS. 20 and 21 are negative derivative curves for RFCal melts with the guards turned off and with guards on at a guard heater ratio of 1.5×. With guards off, the melt peaks were both broader and more varied in Tm than with the guards on.

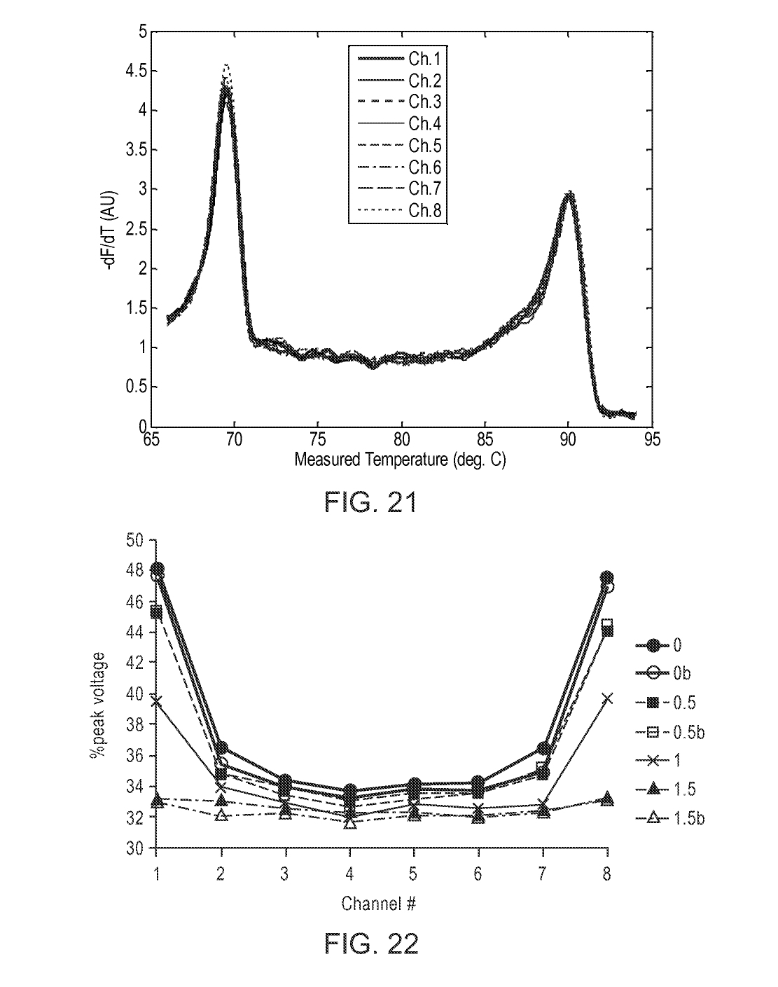

FIG. 22 illustrates the absolute value of drive voltages for the multiplexed sensors when at 65 deg. C under various guard ratios and shows the effect of the thermal guards. With the guard ratio of 1.5×, all channels require the same drive voltage because they have the same thermal load. This balancing of current in the multiplexed sensors may be responsible for the improvement in Tm variance. Thus, in some embodiments, the thermal guard heaters 1504 may improve the uniformity of temperature in the outside channels and may make the calibration more accurate by balancing the current imbalance in the multiplexed sensors.

Embodiments of the present invention have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention. For example, in the embodiments illustrated in FIGS. 15-18, the thermal guard heaters 1504 are thin-film resistive elements of the microfluidic device 1500. However, this is not required, and some alternative embodiments may use other means of heating (e.g., the microfluidic system 100 may include one or more non-contact lasers or infrared (IR) heating elements that may be used to heat portions of the thermal boundaries of one or more heated zones).

In some alternative embodiments, a laser or IR source may be employed to heat the regions adjacent to the outside channels and to function as the guard heaters described in FIGS. 15-18. In some embodiments, the wavelength of the laser/IR source may be selected in the absorption region of the chip material. In some embodiments, the temperature in the regions illuminated by the laser/IR beam may be elevated by the absorbed laser/IR energy so that these regions could function as the guard heaters similar to the resistive heaters without physically forming metal traces. In some embodiments, regions to be heated may be painted with materials that have large absorption coefficient at the laser/IR wavelength so that laser/IR energy can be absorbed more effectively. In some embodiments, the laser/IR beams may be shaped by optics to localize the heated region without disturbing the normal operation of the other heaters (e.g., resistive sensors 212). In some embodiments, the laser/IR beams may be scanned in the region to be used as guard heaters to provide elevated temperatures. In some embodiments, the laser/IR source may be continuous working or pulsed. In some embodiments, the temperature of the non-contact heaters may be adjusted by tuning laser/IR beam power, pulse width, repetition rate, wavelength, rate of scanning, or location of illumination.

For another example, although some embodiments described above relate to thermal control for rapid PCR and/or high-resolution melt analysis, some alternative embodiments may relate to other thermally mediated biochemical reactions, such as, for example and without limitation, sample extraction. Also, although embodiments have been described in the context of temperature measurements, some alternative embodiments may use the alternating polarity multiplex method with other types of sensors where a current imbalance due to temperature gradients exists. For example and without limitation, some alternative embodiments may apply the thermal guard heaters to a resistive strain sensor network in the presence of a temperature gradient. What is claimed is:

1. A system comprising:
a device including:
a heated zone including two or more resistive sensors; and
a common electrode connected to each of the two or more resistive sensors;
one or more thermal guard heaters configured to heat a portion of a thermal boundary of the heated zone;
a thermal control circuit configured to:
(i) drive the two or more resistive sensors with heater control signals,
(ii) drive the one or more thermal guard heaters with guard heater control signals;
(iii) measure the resistance of each of the two or more resistive sensors, and
(iv) update the heater control signals using the measured resistances to balance a thermal load between the two or more resistive sensors by varying the guard heater control signals.

2. The system of claim 1, wherein the heater control signals have alternating polarities such that adjacent resistive sensors of the two or more resistive sensors are driven with heater control signals having opposite polarities.

3. The system of claim 1, wherein the device comprises two or more microfluidic channels that pass through the heated zone.

4. The system of claim 3, wherein each of the two or more resistive sensors is associated with a microfluidic channel of the two or more microfluidic channels.

5. The system of claim 4, wherein the one or more thermal guard heaters are not associated with a microfluidic channel of the two or more microfluidic channels.

6. The system of claim 1, wherein each of the one or more thermal guard heaters comprises a resistive heater.

7. The system of claim 6, wherein the resistive heater is a thin-film resistive heater.

8. The system of claim 7, wherein the thin-film resistive heater is a thin-film nickel or platinum resistive heater.

9. The system of claim 1, wherein the one or more thermal guard heaters comprise one or more non-contact lasers or one or more infrared heaters.

10. The system of claim 1, wherein the common electrode is a split common electrode comprising a pair of common electrode branches.

11. The system of claim 1, wherein the thermal control circuit is configured to drive the two or more resistive sensors with heater control signals having alternating polarities such that an equal number of the two or more resistive sensors are driven with signals of positive and negative polarities.

12. The system of claim 1, further comprising two or more thermal guard heaters configured to heat portions of the thermal boundary of the heated zone.

13. The system of claim 1, further comprising four or more thermal guard heaters configured to heat portions of the thermal boundary of the heated zone.

14. The system of claim 1, wherein the thermal control circuit is configured to optimize a ratio of a thermal guard heater drive voltage to a resistive heater drive voltage such that the two or more resistive heaters have substantially the same measured resistances and drive voltages.

15. The system of claim 1, wherein the one or more thermal guard heaters comprise a first thermal guard heater, the two or more resistive sensors comprise a first resistive sensor that is adjacent to the first thermal guard heater, and the thermal control circuit is configured to drive the first thermal guard heater with a voltage that is proportional to a voltage with which the first resistive sensor is driven.

16. The system of claim 15, wherein the voltage with which the first thermal guard heater is driven is equal to the voltage with which the first resistive sensor is driven multiplied by a constant, and the constant is within a range greater than or equal to 0.5 and less than or equal to 3.

17. The system of claim 16, wherein the voltage with which the first thermal guard heater is driven is equal to the voltage with which the first resistive sensor is driven multiplied by a constant, and the constant is within a range greater than or equal to 1 and less than or equal to 2.

18. The system of claim 17, wherein the constant is equal to 1.5.

19. The system of claim 1, wherein the thermal control circuit is configured to measure the resistance of each of the one or more thermal guard heaters.

20. The system of claim 19, wherein the thermal control circuit is configured to determine the one or more heater control signals used to drive the one or more thermal guard heaters based on the measured resistance of each of the one or more thermal guard heaters.

21. The system of claim 1, wherein the one or more thermal guard heaters comprise a first thermal guard heater, the two or more resistive sensors comprise a first resistive sensor that is adjacent to the first thermal guard heater, and the thermal control circuit is configured to drive the first thermal guard heater and the first resistive sensor with heater control signals having opposite polarities.

22. A thermal control method for a device comprising (i) a heated zone including two or more resistive sensors and (ii) a common electrode connected to each of the two or more resistive sensors, the method comprising:
driving the two or more resistive sensors with heater control signals;
measuring the resistance of each of the two or more resistive sensors;
updating the heater control signals using the measured resistances; and
using one or more thermal guard heaters to heat at least a portion of a thermal boundary of the heated zone.

23. The method of claim 22, wherein the heater control signals have alternating polarities such that adjacent resistive sensors of the two or more resistive sensors are driven with heater control signals having opposite polarities.

24. The method of claim 22, further comprising driving the two or more resistive sensors with heater control signals having alternating polarities such that an equal number of the two or more resistive sensors are driven with signals of positive and negative polarities.

25. The method of claim 22, further comprising:
driving a first resistive sensor of the two or more resistive sensors with a first voltage, wherein the first resistive sensor is adjacent to a first thermal guard heater of the one or more thermal guard heaters; and
driving the first thermal guard heater with a second voltage that is proportional to the first voltage.

26. The method of claim 25, wherein the second voltage is equal to the first voltage multiplied by a constant, and the constant is within a range greater than or equal to 0.5 and less than or equal to 3.

27. The method of claim 26, wherein the second voltage is equal to the first voltage multiplied by a constant, and the constant is within a range greater than or equal to 1 and less than or equal to 2.

28. The method of claim 27, wherein the constant is equal to 1.5.

29. The method of claim 22, further comprising measuring the resistance of each of the one or more thermal guard heaters.

30. The method of claim 29, further comprising:
determining one or more heater control signals used to drive the one or more thermal guard heaters based on the measured resistance of each of the one or more thermal guard heaters; and
driving the one or more thermal guard heaters with the one or more heater control signals.

31. The method of claim 22, further comprising: driving a first resistive sensor of the two or more resistive sensors with a first heater control signal, wherein the first resistive sensor is adjacent to a first thermal guard heater of the one or more thermal guard heaters; and
driving the first thermal guard heater with a second heater control signal, wherein the first and second heater control signals have opposite polarities.
